(19) United States
(12) Patent Application Publication
(10) Pub. No.: US 2023/0183463 A1
(43) Pub. Date: Jun. 15, 2023

(54) Thermoplastic Elastomer Compositions for Use in Pharmaceutical Articles

(71) Applicant: Celanese International Corporation, Irving, TX (US)

(72) Inventors: Peite Bao, Shanghai (CN); Shane H. Larsen, Houston, TX (US); Wanli Wang, Shanghai (CN); Krishnan Anantha Narayana Iyer, Manvel, TX (US); Anas Mujtaba, Kraainem (BE); Jianya Cheng, Kingwood, TX (US); Sunny Jacob, Seabrook, TX (US)

(21) Appl. No.: 17/924,388

(22) PCT Filed: May 11, 2021
(86) PCT No.: PCT/US2021/031689

§ 371 Date: Nov. 10, 2022

Related U.S. Application Data
(60) Provisional application No. 63/023,561, filed on May 12, 2020.

(51) Int. Cl. C08L 23/28

(52) U.S. Cl. CPC C08L 23/28; C08L 2207/04; C08L 2203/02; C08L 2205/22

(57) ABSTRACT

Thermoplastic elastomer compositions comprising brominated isobutylene paramethyl-styrene terpolymers, one or more thermoplastic polyolefins, optionally, one or more soft thermoplastic elastomers, and a curing system to form such thermoplastic elastomeric compositions that are suitable for use in pharmaceutical articles.

### CROSS REFERENCE TO RELATED APPLICATIONS

This application claims the priority benefit of U.S. Ser. No. 63/023,561, filed May 12, 2020, which is incorporated herein by reference.

### FIELD

The present disclosure relates to thermoplastic elastomeric compositions comprising brominated isobutylene paramethyl-styrene terpolymers, one or more thermoplastic polyolefins, optionally, one or more soft thermoplastic elastomers, and curing systems to form such thermoplastic elastomeric compositions that are suitable for use in pharmaceutical articles.

### BACKGROUND

Unlike conventional vulcanized rubbers, thermoplastic elastomers are rubber-like materials that can be processed and recycled. When the thermoplastic elastomer contains a vulcanized rubber, it may also be referred to as a thermoplastic vulcanizate (TPV), defined as a thermoplastic elastomer with a chemically cross-linked rubbery phase, produced by dynamic vulcanization. Filled and vulcanized elastomers have been widely used for pharmaceutical packaging (e.g., pharmaceutical stoppers and seals) to preserve drugs and medicines, thus constituting 50% of a typical pharmaceutical stopper. Cleanliness of the elastomers is of vital importance to ensure low levels of extractables and leachables. Accordingly, the increasing demand by end users for pharmaceutical stoppers and seals with a low level of extractables and leachables has put pressure on both stopper manufacturers and raw material suppliers in the healthcare industry.

Manufacturing elastomeric materials can be achieved by injection molding, transfer molding, or compression molding. Pharmaceutical stoppers are manufactured, for the most part, using a compression molding method with thermoset materials. Stopper manufacturers have been unable to use injection molding due to the challenging physical properties required for the pharmaceutical stopper applications, from thermoset materials with low enough viscosity and fast enough cure times to be used in injection molding. However, if a TPV material could be developed for use in injection molding, the benefits would include less scrap, higher cleanliness, and lower labor cost.

Non-limiting examples of desirable elastomers properties include: sealing and re-sealing performance, ability to be penetrated by needles without resulting in significant fragmentation, and retention of physical dimensions and properties upon high temperature sterilization or sterilization via radiation for stoppers formed from elastomers. Other semi-crystalline materials, such as plastics and thermoplastic elastomers, are not able to match the elasticity, needle penetrability, low punch force requirements and dimension stability performance of amorphous elastomers.

The transition in elastomers and elastomer compositions used for pharmaceutical applications has been driven by many factors, including the need for high cleanliness stoppers that are compatible with modern sensitive drugs, the use of high purity ingredients to minimize any chemical species that migrate out of stoppers and interact with medicine (drug compatibility/turbidity), use of low amounts of clean curatives to assure drug stability/compatibility, tight control on visible and non-visible particle contamination, and the need for low extractables/leachables. Risk to drug product quality and/or patient safety may exist when elastomeric components come into direct or indirect contact with pharmaceutical products. Elastomeric components used in pharmaceutical packaging/delivery systems must be proven suitable for their intended use based on aspects of protection, compatibility, performance, and safety.

The levels of extractable and leachable parenteral drug packaging stoppers have been subject to strict regulations. The test procedures and requirements for elastomeric components are found in Elastomeric Closures for Injections USP “381”, which address a number of medical and pharmaceutical concerns, including: difficult-to-pierce closures (too much required piercing force can result in needle slippage and subsequent needle pricks); inferior septa self-sealing (leading to leakage during fluid transfer, thus creating a hazardous work area, as well as waste, while compromising the preservation of the preparation via evaporation, non-sterility and pharmaceutical spoilage); fragmentation (fragments generated after needle penetration of the septum can contaminate contents and/or create a leak path);

biocompatibility (per in vitro and in vivo testing, to ensure no undesired biological effects. Beyond the baseline requirements provided in USP “381”, elastomers will need to be qualified for intended use commensurate with the level of risk to drug product quality and patient safety. These evaluations would encompass studies for extractables and leachables. In order to achieve good drug compatibility and minimize extractables and leachables, stopper manufacturers generally use raw materials of high cleanliness, optimize formulations to contain least amount of curing agent and other additives and comply with good manufacturing practice (GMP) or other ISO standards.

Among the commercially available elastomers, halobutyl polymers (e.g., chlorobutyl and bromobutyl) remain the elastomers of choice worldwide for pharmaceutical stoppers and seals, this due to their relative high cleanliness, high gas and moisture barrier performance, as well as low level of additives and impurities. Furthermore, high quality pharmaceutical stoppers today are largely made using the halobutyl polymers instead of regular butyl due to the versatile curing of the former elastomer. Regular butyl requires high dosage of sulfur and/or zinc containing curing agents which is not acceptable. Bromobutyl elastomer can be cured using low level of zinc-free and sulfur-free curing agents and therefore provide high degree of cleanliness.

Brominated isobutylene para-methylstyrene (BIMSM) elastomer is a very clean elastomer that has been adopted by the industry to make stoppers for packaging expensive drugs such as antibiotics, water for injection as well as vaccines and biological products. Unlike halobutyl, BIMSM elastomer has a fully saturated backbone and therefore does not need butylated hydroxylated toluene (BHT) or other antioxidant and stabilizer such as epoxidized soy bean oil (ESBO) for stabilization. The polymer also contains no oligomer, a by-product of butyl and halobutyl polymerization process. BHT, oligomer and other additives have been found to be extractables that may lead to drug incompatibility with antibiotics and other sensitive drugs. The use of natural rubber is limited due to ‘latex sensitivity’ issue. The use of other synthetic rubbers are hampered by high gas and moisture permeability, poor oxidation and heat resistance.

Apart from additives and by-products in the elastomer compositions, curing agents adopted for vulcanization are major source of extractables for pharmaceutical stoppers. BIMSM can be cross-linked effectively through the benzylic bromine functional groups and requires less curative than halobutyl for effective crosslinking. Nevertheless any curing agents and processing additives used can potentially be extracted and cause drug incompatibility for sensitive drugs and biological products. Yet, remain the challenges of developing an optimal curing system that would contribute to the improvement of thermoplastic elastomer properties while preventing any undesirable drug interaction.

Therefore there is a need to simplify the process of producing pharmaceutical stoppers and other medical articles via the use of the inventive thermoplastic elastomer compositions. The thermoplastic elastomer compositions described here can be processed via conventional high throughput thermoplastic processes such as injection molding or extrusion. The prior art that have looked at solving this challenge have employed thermoplastic elastomeric compounds containing a hydrogenated derivative of a block copolymer consisting of an aromatic vinyl compound and a conjugated diene, a rubber softener, and an olefin-based resin; however, such rubber stoppers showed a high coefficient of gas permeability, thus causing a problem of insufficient gas-barrier properties with respect to the content fluid. The present invention solves the challenge of producing medical sealing articles made by using thermoplastic elastomers and thermoplastic vulcanizates that show improved gas-barrier properties, self-sealing behavior, and low punch force.

The present invention also describes a medical container stopper, composed of a thermoplastic vulcanizate, obtained via dynamically cross-linking BIMSM elastomers in the presence of a thermoplastic phase and a “soft thermoplastic elastomer” phase. Additionally, the BIMSM elastomer in the thermoplastic elastomer is crosslinked using cure systems that demonstrate good processability and reduced leachables for use in pharmaceutical articles.

### DESCRIPTION OF DRAWINGS

FIG. 1 depicts a comparison of self-sealing, fragmentation and punch force properties for the inventive compositions.

FIG. 2 depicts a comparison of stress relaxation % versus time for the inventive compositions.

FIG. 3 depicts a comparison of final stress relaxation % for the inventive compositions.

### SUMMARY

The present disclosure relates to thermoplastic elastomer compositions comprising one or more brominated isobutylene paramethyl-styrene terpolymers and polypropylene homopolymers for pharmaceutical articles comprising such blends of homopolymers and terpolymers.

The present disclosure further relates to a thermoplastic elastomer composition comprising: one or more brominated isobutylene paramethyl-styrene terpolymers; and 10 to 50, or 10 to 80, parts by weight per hundred parts by weight rubber (phr) of a polypropylene homopolymer; wherein the thermoplastic elastomer composition is cured using a phenolic resin-based cure system, a sulfur-based cure system, or an amine-based cure system.

The present disclosure further relates to a thermoplastic elastomer composition comprising: one or more brominated isobutylene paramethyl-styrene terpolymers; 10 to 50, or 10 to 80, parts by weight per hundred parts by weight rubber (phr) of a polypropylene homopolymer; and 10 to 100 phr of a process oil comprising a polyisobutene polymer; wherein the thermoplastic elastomer composition is cured using a phenolic resin-based cure system, a sulfur-based cure system, or an amine-based cure system; and wherein the thermoplastic elastomer composition has a hardness (Shore A) of 40 to 90, or 20 to 90.

The present disclosure further relates to thermoplastic elastomer compositions comprising one or more at least partially crosslinked brominated isobutylene paramethyl-styrene terpolymers and polypropylene homopolymers for pharmaceutical articles comprising such blends of terpolymers and homopolymers.

The present disclosure further relates to a thermoplastic vulcanizate composition comprising: an elastomer phase comprising one or more brominated isobutylene paramethyl-styrene terpolymers, 10 to 90 parts by weight per hundred parts by weight rubber (phr) of a thermoplastic phase comprising a blend of one or more thermoplastic polyolefins and one or more soft thermoplastic elastomers, wherein the soft thermoplastic elastomer has a shore A hardness from 20 to 96, a shore D hardness from 20 to 50 and a tensile strength at break of 2 to 20 MPa; and 10 to 100 phr of a process oil; wherein the elastomer phase is cured using a phenolic resin-based cure system or an amine-based cure system

The present disclosure further relates to a thermoplastic vulcanizate composition wherein the one or more soft thermoplastic elastomers comprises an olefin based block copolymer comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C.

The present disclosure further relates to a thermoplastic vulcanizate composition wherein the one or more soft thermoplastic elastomers comprises a propylene based olefin block copolymer (OCP) blend comprising an ethylene-propylene (EP) copolymer, isotactic polypropylene (iPP) and an EP-iPP diblock polymer.

The present disclosure further relates to a thermoplastic vulcanizate composition wherein the one or more soft thermoplastic elastomers comprises a styrene-isobutylene styrene (SIBS) polymer.

The present disclosure further relates to a thermoplastic vulcanizate composition wherein the one or more soft thermoplastic elastomers comprises a propylene-based elastomer containing units derived from major fraction of propylene and from about 5 to about 25 wt % of one or more comonomers selected from ethylene and/or C4-C12 α-olefins.

The present disclosure further relates to a thermoplastic vulcanizate composition wherein the one or more soft thermoplastic elastomers comprises a 4-methyl-1-pentene/α-olefin pcopolymer comprising 50 to 100% by weight of structural units derived from methyl pentene and 0 to 50% by weight of structural units derived from at least one olefin selected from olefins having 2 to 20 carbon atoms, except 4-methyl-1-pentene.

The present disclosure further relates to a thermoplastic vulcanizate composition wherein the one or more thermoplastic polyolefins comprises a propylene-based polymer, an ethylene-based thermoplastic polymer, a polypropylene homopolymer (PPH), or any combination thereof.

The present disclosure further relates to a thermoplastic vulcanizate composition wherein the elastomer phase is cured using amine cure system comprising one or more amine curing agents present at 0.1 to 10 phr and wherein the one or more amine curing agents is selected from (6-aminohexyl)carbamic acid, N,N′-dicinnamylidene-1,6-hexamethylenediamine, 4,4′-methylenebis(cyclohexylamine)carbamate, 1,3,5-triallyl-1,3,5-triazine-2,4,6(1H,3H,5H)-trione, trimethylallyl isocyanurate, N-(1,3-dimethylbutyl)-N′-phenyl-p-phenylenediamine, N,N′-Diphenyl-p-phenylenediamine, N,N-Diethyl-p-phenylenediamine.

The present disclosure further relates to a thermoplastic vulcanizate composition wherein the cure system is substantially free of heavy metal fractions, phenolic resin or sulfur.

The present disclosure further relates to a thermoplastic vulcanizate composition further comprising a cyclopentadiene-based hydrocarbon resin having a glass transition temperature (Tg) of greater than 20° C.

The present disclosure further relates to a thermoplastic vulcanizate composition that shows improved coring performance, self-sealing, low punch force, excellent oxygen barrier properties, and improved compression set at elevated temperatures.

The present disclosure further relates to the above thermoplastic vulcanizate composition showing a shore A hardness in the range of 20 to 90, a tensile strength at break of 1.5 to 8 MPa, compression set at 70° C. of <35%, and oxygen permeability <0.2 cc*mm/(m2-day-mmHg) measured at 40° C.

### DETAILED DESCRIPTION

The present disclosure relates to thermoplastic elastomer compositions comprising one or more brominated isobutylene paramethyl-styrene terpolymers (BIMSM) and polypropylene homopolymers (PPH) that are suitable for use for pharmaceutical articles, and other articles comprising such blends of PPH and one or more BIMSM.

Embodiments of the present disclosure include thermoplastic elastomer compositions comprising a blend of (a) one or more BIMSM, and (b) 20 to 50, or 15 to 90, parts by weight per hundred parts by weight rubber (phr) of a PPH, wherein the thermoplastic elastomer composition is cured using a phenolic resin-based cure system, a sulfur-based cure system, or an amine-based cure system.

Preferably, the PPH have a melt flow rate (MFR) (230° C./2.16 kg) of 0.5 g/10 min to 2000 g/10 min (or 0.5 g/10 min to 1500 g/10 min, or 0.5 g/10 min to 1000 g/10 min, or 0.5 g/10 min to 500 g/10 min, or 0.5 g/10 min to 100 g/10 min, more preferably 0.5 g/10 min to 20 g/10 min), based on the ASTM D1238 test method). Preferably, the one or more BIMSM are brominated copolymers of isobutylene and paramethyl-styrene that has a Mooney viscosity (ML 1+8, 125° C.) of 30 MU to 50 MU, according to the ASTM D1646 test method, and/or a benzylic bromine content of 0.3 mol % to 5 mol %.

Embodiments of the present disclosure further include thermoplastic elastomer compositions comprising a blend of (a) one or more BIMSM, (b) 20 to 50, or 10 to 90 parts by weight per hundred parts by weight rubber (phr) of a thermoplastic polyolefin, (c) one or more curing agent(s) (e.g., present at 0.1 phr to 15 phr, or 0.5 phr to 10 phr), and (d) a process oil (e.g., present at 40 phr to 80 phr, or 50 phr to 70 phr), wherein the thermoplastic elastomer composition is cured using a phenolic resin-based cure system, an alkylation cure system initiated by ZnO, a sulfur-based cure system, or an amine-based cure system.

The present disclosure further relates to a thermoplastic vulcanizate composition comprising: an elastomer phase comprising one or more brominated isobutylene paramethyl-styrene terpolymers, 10 to 90 parts by weight per hundred parts by weight rubber (phr) of a thermoplastic phase comprising a blend of one or more thermoplastic polyolefins and one or more soft thermoplastic elastomers, wherein the soft thermoplastic elastomer has a shore A hardness from 20 to 96, a shore D hardness from 20 to 50 and a tensile strength at break of 2 to 20 MPa; and 10 to 100 phr of a process oil; wherein the elastomer phase is cured using a phenolic resin-based cure system or an amine-based cure system

The present disclosure further relates to a thermoplastic vulcanizate composition wherein the one or more soft thermoplastic elastomers comprises an olefin based block copolymer (OBC) comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C. Preferably, the OBC has a melt flow rate (MFR) (190° C./2.16 kg) of 0.5 to 30 g/10 min (most preferred 0.5 to 6 g/10 min), density from 0.85 to 0.90 g/ml (most preferred 0.860-0.880 g/ml), melting point from 100 to 130° C. (most preferred from 115 to 125° C.), shore A hardness from 30 to 95 (most preferred from 50 to 85), tensile strength from 1.5 to 18 MPa (most preferred from 2 to 15 MPa), compression set at 70° C. from 20 to 120% (most preferred from 40 to 100%).

The present disclosure further relates to a thermoplastic vulcanizate composition wherein the one or more soft thermoplastic elastomers comprises a propylene based olefin block copolymer (OCP) blend comprising an ethylene-propylene (EP) copolymer, isotactic polypropylene (iPP) and an EP-iPP diblock polymer. Preferably, the OBC blend has a melt flow rate (MFR) (230° C./2.16 kg) of 0.5 to 100 g/10 min (or 1 to 75 g/10 min, or 2 to 50 g/10 min, or 3 to 40 g/10 min, based on the ASTM D1238 test method). Preferably, the OBC blend shows a shore A hardness from 30 to 98 (or 40 to 95, 50 to 95, 60 to 95). Preferably, the OBC blend shows a shore D hardness from 5 to 60 (or 10 to 55, 15 to 50, 15 to 45). Preferably, the OBC blend shows an ethylene content of 90 to 15 wt % (or 85 to 20, 80 to 25, 77 to 30). Preferably, the OBC blend shows a vicat softening point of 20 to 150° C. (or 30 to 140° C., 40 to 135° C., 50 to 130° C.). Preferably, the OBC blend shows a tensile strength at break of 1.5 to 20 MPa (or 2 to 18, or 2 to 17, or 2.5 to 16).

The present disclosure further relates to a thermoplastic vulcanizate composition wherein the one or more soft thermoplastic elastomers comprises a styrene-isobutylene styrene (SIBS) polymer. Preferably, the SIBS polymer has a melt flow rate (MFR) (230° C./2.16 kg) of 0.05 to 30 g/10 min (most preferred 0.1 to 25 g/10 min), tensile strength at break from 4 to 25 MPa (preferred from 6 to 20 MPa), shore A hardness from 15 to 60 (most preferred from 20 to 50), compression set at 70° C. from 30 to 120% (most preferred from 48 to 96%). A SIBS polymer can also be used in place of the polybutene oil.

The present disclosure further relates to a thermoplastic vulcanizate composition wherein the one or more soft thermoplastic elastomers comprises a propylene-based elastomer containing units derived from major fraction of propylene and from about 5 to about 25 wt % of one or more comonomers selected from ethylene and/or C4-C12 α-olefins. Preferably, the propylene-based elastomer has a melt flow rate (MFR) (190° C./2.16 kg) 0.2 to 25 g/10 min (most preferred 0.5 to 20 g/10 min), ethylene content from 1 wt % to 25 wt % (most preferred from 3 to 19 wt %).

The present disclosure further relates to a thermoplastic vulcanizate composition wherein the one or more soft thermoplastic elastomers comprises 50 to 100% by weight of structural units derived from methyl-1-pentene and 0 to 50% by weight of structural units derived from at least one olefin selected from olefins having 2 to 20 carbon atoms, except 4-methyl-1-pentene. Preferably, the 4-methyl-1-pentene copolymer has an MFR (230° C., 2.16 kg) from 0.5 to 20 g/10 min (most preferred from 2 to 15 g/10 min), tensile strength at break from 20 to 30 MPa (most preferred from 25 to 35 MPa), Tg from −10 to 50° C. (most preferred from 10 to 40° C.).

The present disclosure further relates to a thermoplastic vulcanizate composition wherein the one or more soft thermoplastic elastomers comprises:

(1) an olefin based block copolymer comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C.,

(2) a propylene based olefin block copolymer (OCP) blend comprising an ethylene-propylene (EP) copolymer, isotactic polypropylene (iPP) and an EP-iPP diblock polymer,

(3) a styrene-isobutylene styrene (SIBS) polymer,

(4) a propylene-based elastomer containing units derived from major fraction of propylene and from about 5 to about 25 wt % of one or more comonomers selected from ethylene and/or C4-C12 α-olefins, and

(5) a 4-methyl-1-pentene/α-olefin copolymer comprising 50 to 100% by weight of structural units derived from 4-methyl-1-pentene and 0 to 50% by weight of structural units derived from at least one olefin selected from olefins having 2 to 20 carbon atoms, except 4-methyl-1-pentene, or any combination thereof.

The present disclosure further relates to a thermoplastic vulcanizate composition wherein the one or more thermoplastic polyolefins comprises a propylene-based polymer, an ethylene-based thermoplastic polymer, a polypropylene homopolymer (PPH), or any combination thereof.

The present disclosure further relates to a thermoplastic vulcanizate composition wherein the elastomer phase is cured using amine cure system comprising one or more amine curing agents present at 0.1 to 10 phr and wherein the one or more amine curing agents is selected from (6-aminohexyl)carbamic acid, N,N′ -dicinnamylidene-1,6-hexamethylenediamine, 4,4′-methylenebis(cyclohexylamine)carbamate, 1,3,5-triallyl-1,3,5-triazine-2,4,6(1H,3H,5H)-trione, trimethylallyl isocyanurate, N-(1,3-dimethylbutyl)-N′-phenyl-p-phenylenediamine, N,N′-Diphenyl-p-phenylenediamine, N,N-Diethyl-p-phenylenedi amine.

The present disclosure further relates to a thermoplastic vulcanizate composition wherein the cure system is substantially free of heavy metal fractions, phenolic resin or sulfur, in compliance with FDA 21 CFR 177.2600.

The present disclosure further relates to a thermoplastic vulcanizate composition, wherein the process oil comprises a polyisobutene polymer.

The present disclosure further relates to a thermoplastic vulcanizate composition, wherein the process oil comprises a propylene-based elastomer containing units derived from major fraction of propylene and from about 5 to about 25 wt % of one or more comonomers selected from ethylene and/or C4-C12 α-olefins.

The present disclosure further relates to a thermoplastic vulcanizate composition further comprising a cyclopentadiene-based hydrocarbon resin having a glass transition temperature (Tg) of greater than 20° C.

The present disclosure further relates to a thermoplastic vulcanizate composition, wherein the elastomer phase is at least partially crosslinked.

Embodiments of the present disclosure further include thermoplastic vulcanizate compositions showing a shore A hardness in the range of 20 to 90, a tensile strength at break of 1.5 to 8 MPa, compression set at 70° C. of <35%, and oxygen permeability <0.2 cc*mm/(m2-day-mmHg) measured at 40° C.

Advantageously, such thermoplastic elastomer compositions provide improved physical properties required for pharmaceutical stopper applications, such as higher resistance to heat degradation, better elastic properties after curing, enhanced aging resistance and abrasion resistance, stronger gas barrier, good coring and reseal behavior, improved low permeability, enhanced resealability, low fragmentation, enhanced toughness, improved melt flow and injection molding capabilities, and improved leachable profile compared to traditional TPVs or thermoset rubbers. Because of these improved properties, the thermoplastic elastomer compositions described herein may be useful in producing higher quality pharmaceutical articles.

The present disclosure also relates to the methods for making the foregoing thermoplastic elastomer and thermoplastic vulcanizate compositions comprising: blending the thermoplastic phase with the one or more BIMSM, curing agents (also referred to as “curatives”) suitable for the phenolic resin-based cure system, the sulfur-based cure system, or the amine-based cure system, a process oil, and optionally other additives. Preferably, the process oil comprises a polyisobutene polymer.

Said thermoplastic elastomer compositions may be useful in pharmaceutical applications to improve physical properties such as permeability, resealability, fragmentation, toughness, melt flow and injection molding capabilities, and leachables. Thermoplastic vulcanizate compositions of the present invention, based on BIMSM, a thermoplastic phase comprising a thermoplastic polyolefin and soft thermoplastic elastomer, process oil, and curing agents, provide gas barrier and compression set properties comparable to butyl rubber. As such, and with the advantage of being capable of being injection molded, plastic articles can be made from formulations of the present invention for such uses as seals, closures, and other articles previously made from butyl rubber, particularly medical container seals, syringe tips, syringe plunger tips, penetrable septa, stoppers, bottle caps, and plugs. Other articles can be made from the thermoplastic elastomer compositions of the present invention, such as the following industrial and consumer products: food and drink container seals, printer cartridge seals, and other products needing both flexibility and barrier properties, as a suitable replacement for butyl rubber.

### Definitions and Test Methods

The new notation for the Periodic Table Groups is used as described in Chemical and Engineering News, 63(5), 27 (1985).

Unless otherwise indicated, room temperature is 23° C.

The following abbreviations are used herein: PPH is polypropylene homopolymer; BIMSM is brominated isobutylene paramethyl-styrene; PIB is polyisobutene; MFR is melt flow rate; Me is methyl; iPr is isopropyl; Ph is phenyl; wt % is weight percent; mol % is mole percent.

An “olefin,” alternatively referred to as “alkene,” is a linear, branched, or cyclic compound of carbon and hydrogen having at least one double bond.

A “polymer” has two or more of the same or different mer units. A “homopolymer” is a polymer having mer units that are the same. The term “polymer” as used herein includes, but is not limited to, homopolymers, copolymers, terpolymers, etc. The term “polymer” as used herein also includes impact, block, graft, random, and alternating copolymers. The term “polymer” shall further include all possible geometrical configurations unless otherwise specifically stated. Such configurations may include isotactic, syndiotactic, and random symmetries.

The term “blend” as used herein refers to a mixture of two or more polymers. Blends may be produced by, for example, solution blending, melt mixing, or compounding in a shear mixer. Solution blending is common for making adhesive formulations comprising baled butyl rubber, tackifier, and oil. Then, the solution blend is coated on a fabric substrate, and the solvent evaporated to leave the adhesive.

The term “monomer” or “comonomer,” as used herein, can refer to the monomer used to form the polymer (i.e., the unreacted chemical compound in the form prior to polymerization) and can also refer to the monomer after it has been incorporated into the polymer, also referred to herein as a “[monomer]-derived unit”. Different monomers are discussed herein, including propylene monomers, ethylene monomers, and diene monomers.

“Different” as used to refer to monomer mer units indicates that the mer units differ from each other by at least one atom or are different isomerically.

As used herein, when a polymer is referred to as “comprising, consisting of”, or consisting essentially of a monomer or monomer-derived units, the monomer is present in the polymer in the polymerized/derivative form of the monomer. For example, when a copolymer is said to have an “isobutylene” content of 35 wt % to 55 wt %, it is understood that the mer unit in the copolymer is derived from isobutylene in the polymerization reaction and said derived units are present at 35 wt % to 55 wt %, based upon the weight of the copolymer.

The mol ratio of first olefin comonomer-derived units to second olefin comonomer-derived units is determined using HNMR where the different chemical shift of a hydrogen atom can be associated with each comonomer. Then, the relative intensity of the NMR associated with said hydrogens provides a relative concentration of each of the comonomers.

As used herein, “thermoplastic phase” means a solid, generally high molecular weight polymeric plastic material, which may be referred to as a thermoplastic resin. This resin is a crystalline or a semi-crystalline polymer, and can be a resin that has a crystallinity of at least 25 percent as measured by differential scanning calorimetry. Polymers with a high glass transition temperature are also acceptable as the thermoplastic resin. In one or more embodiments, the melt temperature of these resins should be lower than the decomposition temperature of the rubber. Reference to a thermoplastic resin will include a thermoplastic resin or a mixture of two or more thermoplastic resins. The thermoplastic phase may also include a soft thermoplastic elastomer, as described further in this specification.

As used herein, “soft thermoplastic elastomer” means a thermoplastic elastomer having a shore A hardness ranging from 20 to 96 and when measured on the shore D scale from 20 to 50, a tensile strength at break of 2 to 20 MPa. Examples of soft thermoplastic elastomers are described further in the specification.

As used herein, “thermoplastic polyolefin” means a polymer formed by polymerizing α-olefins such as ethylene, propylene, 1-butene, 1-hexene, 1-octene, 2-methyl-1-propene, 3-methyl-1-pentene, 4-methyl-1-pentene, 5-methyl-1-hexene, and mixtures thereof. Copolymers of ethylene and propylene or ethylene or propylene with another α-olefin such as 1-butene, 1-hexene, 1-octene, 2-methyl-1-propene, 3-methyl-1-pentene, 4-methyl-1-pentene, 5-methyl-1-hexene or mixtures thereof are also contemplated. These homopolymers and copolymers may be synthesized by using any polymerization technique known in the art such as, but not limited to, the “Phillips catalyzed reactions,” conventional Ziegler-Natta type polymerizations, and metallocene catalysis including, but not limited to, metallocene-alumoxane and metallocene-ionic activator catalysis. Suitable catalyst systems thus include chiral metallocene catalyst systems, see, e.g., U.S. Pat. No. 5,441,920, and transition metal-centered, heteroaryl ligand catalyst systems, see, e.g., U.S. Pat. No. 6,960,635.

In one or more embodiments, the thermoplastic resin is high-crystalline isotactic or syndiotactic polypropylene. These propylene polymers include both homopolymers of propylene, or copolymers with 0.1-30 wt. % of ethylene, or C4-C8 comonomers, and blends of such polypropylenes. The polypropylene generally has a density of from about 0.85 to about 0.91 g/cc, with the largely isotactic polypropylene having a density of from about 0.90 to about 0.91 g/cc. Also, high and ultra-high molecular weight polypropylene that has a low, or even fractional melt flow rate can be used.

The thermoplastic polyolefin resins may have a Mw from about 200,000 to about 700,000, and a Mn from about 80,000 to about 200,000. These resins may have a Mw from about 300,000 to about 600,000, and a Mn from about 90,000 to about 150,000.

These thermoplastic polyolefin resins may have a melt temperature (Tm) that is from about 150 to about 175° C., or from about 155 to about 170° C., or from about 160 to about 170° C. The glass transition temperature (Tg) of these resins is from about —5 to about 10° C., or from about —3 to about 5° C., or from about 0 to about 2° C. The crystallization temperature (Tc) of these resins is from about 95 to about 130° C., or from about 100 to about 120° C., or from about 105 to about 115° C. as measured by DSC and cooled at 10° C./min.

These thermoplastic polyolefin resins generally can have a melt flow rate of up to 400 g/10 min, but the thermoplastic vulcanizates of the invention generally have better properties for many applications where the melt flow rate is less than about 30 g/10 min., preferably less than 10 g/10 min, or less than about 2 g/10 min, or less than about 0.8 g/10 min. Melt flow rate is a measure of how easily a polymer flows under standard pressure, and is measured by using ASTM D-1238 at 230° C. and 2.16 kg load.

Other exemplary thermoplastic resins, in addition to crystalline or semi-crystalline, or crystallizable, polyolefins, include, polyimides, polyesters(nylons), poly(phenylene ether), polycarbonates, styrene-acrylonitrile copolymers, polyethylene terephthalate, polybutylene terephthalate, polystyrene, polystyrene derivatives, polyphenylene oxide, polyoxymethylene, and fluorine-containing thermoplastics. Molecular weights are generally equivalent to those of the thermoplastic polyolefins but melt temperatures can be much higher. Accordingly, the melt temperature of the thermoplastic resin chosen should not exceed the temperature at which the rubber will breakdown, that is when its molecular bonds begin to break or scission such that the molecular weight of the rubber begins to decrease.

As used herein, a “polypropylene homopolymer” (PPH) is a resin defined to be a thermoplastic polymer produced polymerization of propylene monomer. PPH can be isotactic polypropylene, highly isotactic polypropylene, or syndiotactic polypropylene. A PPH may have a melt flow rate (MFR) (230° C./2.16 kg), measured according to ASTM D1238 test method, of from 0.5 g/10 min to 2000 g/10 min.

The term “brominated isobutylene paramethyl-styrene terpolymers” (BIMSM) as used herein includes a brominated copolymer of isobutylene and paramethyl-styrene.

As used herein, “phr” means “parts per hundred parts rubber,” where the “rubber” is the total rubber content of the composition. Herein, only BIMSM is considered to contribute to the total rubber content. Thus, for example, a composition having 40 parts by weight of polypropylene homopolymer for every 100 parts by weight of BIMSM may be referred to as having 40 phr polypropylene homopolymer. Other components added to the composition are calculated on a phr basis. For example, addition of 50 phr of oil to a composition means that 50 g of oil are present in the composition for every 100 g of BIMSM. Unless specified otherwise, phr should be taken as phr on a weight basis.

Rubber refers to any polymer or composition of polymers consistent with the ASTM D1566 definition: “a material that is capable of recovering from large deformations, and can be, or already is, modified to a state in which it is essentially insoluble (but can swell) in boiling solvent”. Elastomer is a term that may be used interchangeably with the term rubber.

Elastomeric composition refers to any composition comprising at least one elastomer as defined above.

A vulcanized rubber compound by ASTM D1566 definition refers to “a crosslinked elastic material compounded from an elastomer, susceptible to large deformations by a small force capable of rapid, forceful recovery to approximately its original dimensions and shape upon removal of the deforming force”. A cured elastomeric composition refers to any elastomeric composition that has undergone a curing process and/or comprises or is produced using an effective amount of a curative or cure package, and is a term used interchangeably with the term vulcanized rubber compound.

A thermoplastic elastomer by ASTM D1566 definition refers to a rubber-like material “that repeatedly can be softened by heating and hardened by cooling through a temperature range characteristic of the polymer, and in the softened state can be shaped into articles”. Thermoplastic elastomers may be microphase separated systems of at least two polymers. One phase is the hard polymer that does not flow at room temperature, but becomes fluid when heated, that gives thermoplastic elastomers its strength. The other phase is a soft rubbery polymer that gives thermoplastic elastomers their elasticity. The hard phase is typically the major or continuous phase.

A thermoplastic vulcanizate by ASTM D1566 definition refers to “a thermoplastic elastomer with a chemically cross-linked rubbery phase, produced by dynamic vulcanization”. Dynamic vulcanization is “the process of intimate melt mixing of a thermoplastic polymer and a suitable reactive rubbery polymer to generate a thermoplastic elastomer with a chemically cross-linked rubbery phase”. The rubbery phase, whether or not cross-linked, is typically the minor or dispersed phase.

As used herein, “tensile strength” means the amount of stress applied to a sample to break the sample. It can be expressed in Pascals or pounds per square inch (psi). ASTM D412-16 can be used to determine tensile strength of a polymer.

“Mooney viscosity” as used herein is the Mooney viscosity of a polymer or polymer composition. The polymer composition analyzed for determining Mooney viscosity should be substantially devoid of solvent. For instance, the sample may be placed on a boiling-water steam table in a hood to evaporate a large fraction of the solvent and unreacted monomers, and then, dried in a vacuum oven overnight (12 hours, 90° C.) prior to testing, in accordance with laboratory analysis techniques, or the sample for testing may be taken from a devolatilized polymer (i.e., the polymer post-devolatilization in industrial-scale processes). Unless otherwise indicated, Mooney viscosity is measured using a Mooney viscometer according to ASTM D1646-17, but with the following modifications/clarifications of that procedure. First, sample polymer is pressed between two hot plates of a compression press prior to testing. The plate temperature is 125° C. +/−10° C. instead of the 50° C. +/−5° C. recommended in ASTM D1646-17, because 50° C. is unable to cause sufficient massing. Further, although ASTM D1646-17 allows for several options for die protection, should any two options provide conflicting results, PET 36 micron should be used as the die protection. Further, ASTM D1646-17 does not indicate a sample weight in Section 8; thus, to the extent results may vary based upon sample weight,

Mooney viscosity determined using a sample weight of 21.5 g +/−2.7 g in the D1646-17 Section 8 procedures will govern. Finally, the rest procedures before testing set forth in D1646-17 Section 8 are 23° C. +/−3° C. for 30 min in air; Mooney values as reported herein were determined after resting at 24° C. +/−3° C. for 30 min in air. Samples are placed on either side of a rotor according to the ASTM D1646-17 test method; torque required to turn the viscometer motor at 2 rpm is measured by a transducer for determining the Mooney viscosity. The results are reported as Mooney Units (ML, 1+4 at 125° C.), where M is the Mooney viscosity number, L denotes large rotor (defined as ML in ASTM D1646-17), 1 is the pre-heat time in minutes, 4 is the sample run time in minutes after the motor starts, and 125° C. is the test temperature. Thus, a Mooney viscosity of 90 determined by the aforementioned method would be reported as a

Mooney viscosity of 90 MU (ML, 1+4 at 125° C.). Alternatively, the Mooney viscosity may be reported as 90 MU; in such instance, it should be assumed that the just-described method is used to determine such viscosity, unless otherwise noted. In some instances, a lower test temperature may be used (e.g., 100° C.), in which case Mooney is reported as Mooney Viscosity (ML, 1+4 at 100° C.), or at T° C. where T is the test temperature.

The compression set of a material is a permanent deformation remaining after release of a compressive stress. The compression set of a material is dependent of the crosslinking density of the material, which is defined as the torque difference between a maximum torque (also referred to as “MH”) and a minimum torque (also referred to as “ML”). MH, ML, and the torque difference “MH-ML” are evaluated by a Moving Die Rheometer

(MDR) testing method, a standard testing method of rubber curing. The MDR can be measured by the ASTM D5289 method, often reported in deciNewton meter (dN.m).

Numerical ranges used herein include the numbers recited in the range. For example, the numerical range “from 1 wt % to 10 wt %” includes 1 wt % and 10 wt % within the recited range.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” or “having” various components or steps, the compositions and methods can also “consist essentially of” or “consist of” the various components and steps.

### Thermoplastic Elastomer Compositions and Compounding

Thermoplastic elastomer compositions described herein comprise: one or more BLMSM having a Mooney viscosity (ML 1+8, 125° C.) of 30 MU to 50 MU, according to the ASTM D1646 test method, and/or a benzylic bromine content of 0.3 mol % to 5 mol %; 20 to 50 phr of a PPH having a melt flow rate (MFR) (230° C./2.16 kg) of 0.5 g/10 min to 2000 g/10 min (or 0.5 g/10 min to 1500 g/10 min, or 0.5 g/10 min to 1000 g/10 min, or 0.5 g/10 min to 500 g/10 min, or 0.5 g/10 min to 100 g/10 min, more preferably 0.5 g/10 min to 20 g/10 min), based on the ASTM D1238 test method); one or more curing agent(s); and a process oil (e.g., present at 40 phr to 80 phr, or 50 phr to 70 phr), and wherein the thermoplastic elastomer composition is cured using a phenolic resin-based cure system, a sulfur-based cure system, or an amine-based cure system.

Thermoplastic elastomer compositions described herein can comprise a single BIMSM or a mixture of two or more BIMSMs (e.g., a dual reactor product or a melt-blended composition).

Notwithstanding, the present disclosure can be applicable to any other suitable halogenated isobutylene paramethyl-styrene terpolymers, wherein the halogen atom is chlorine or fluorine, for example.

Thermoplastic elastomer compositions described herein can comprise a single thermoplastic polymer or a mixture of two or more thermoplastic polymers). For example, in some embodiments the thermoplastic phase comprises homopolymer polypropylene. In other preferred embodiments, the thermoplastic phase is a blend of thermoplastic polyolefin and a soft thermoplastic elastomer phase, where the soft thermoplastic elastomer phase has a shore A hardness ranging from 20 to 96 and when measured on the shore D scale from 20 to 50, a tensile strength at break of 2 to 20 MPa. Preferred thermoplastic polymers and a soft thermoplastic elastomer phase useful in the current invention are detailed in subsequent embodiments.

The thermoplastic phase may be present in the thermoplastic elastomer compositions at 10-90 phr, or 10-50 phr, or 12.5-47.5 phr, or 15-80 phr, or 15-45 phr, or 17.5-42.5 phr, 20-75 phr, or 20-40 phr, 30-70 phr, or 35-65 phr. Thermoplastic elastomer compositions are described further below.

Any suitable vulcanizing agent may be used. Of particular note are curing agents as described in Col. 19, line 35 to Col. 20, line 30 of U.S. Pat. No. 7,915,354, which description is hereby incorporated by reference (e.g., sulfur curing agents, resin curing agents, amine curing agents). The resin curing agent, sulfur curing agent, or amine curing agent, would enable further tuning of the thermoplastic elastomer composition viscoelasticity and improve the material strength. Cure co-agents may also be included (e.g., zinc dimethacrylate (ZDMA)) or those described in the already-incorporated description of U.S. Pat. No. 7,915,354). For pharmaceutical applications, amine curing agents are preferred.

The phenolic resin-based cure system of the thermoplastic elastomer compositions comprises curing agents including one or more of: 0.1-20 phr of stannous chloride; 0.1-15 phr of metal oxide; 0.05-10 phr of stearic acid; and 0.5-20 phr of phenolic resin. The phenolic resin may be present in the thermoplastic elastomer compositions at 0.5-20 phr, 1-15 phr, 1.5-10 phr, or 2-5 phr. The phenolic-resin based cure system is described further below. Examples of curing agents include, but are not limited to, phenolic resins suitable to react with halogen donating activators. Other examples include phenolic resin curing agents (e.g., as described in U.S. Pat. No. 5,750,625, also incorporated by reference herein). The phenolic resin may be selected from any suitable alkylphenol resins, such as octylphenol resins (e.g., SP-1044; SP-1045; HRJ-10518; SP-1055; SP-1056; RIBETAK® R-7530).

The sulfur cure system of the thermoplastic elastomer compositions comprises sulfur curing agents including one or more of: 0.1-10 phr of MBTS; 0.01-5 phr of sulfur; 0.1-10 phr of metal oxide; and 0.5-15 phr of stearic acid.

The amine cure system of the thermoplastic elastomer compositions, preferred for pharmaceutical applications, comprises one or more amine curing agents present at 0.1-10 phr. The one or more amine curing agents include, but are not limited to, (6-aminohexyl)carbamic acid, N,N′-dicinnamylidene-1,6-hexamethylenediamine, 4,4′-methylenebis(cyclohexylamine)carbamate, 1,3,5-triallyl-1,3,5-triazine-2,4,6(1H,3H,5H)-trione, trimethylallyl isocyanurate, N-(1,3-dimethylbutyl)-N′-phenyl-p-phenylenediamine,

N,N′-Diphenyl-p-phenylenediamine, N,N-Diethyl-p-phenylenediamine.

Reinforcing fillers may be present in the thermoplastic elastomer composition at 1-30 phr, 2-25 phr, 5-20 phr, or 10-15 phr. Reinforcing fillers are described further below. Examples of reinforcing fillers include, but are not limited to, mineral reinforcing fillers (talc, calcium carbonate, clay, silica, aluminum trihydrate, and the like). For example, a clay can be present in the thermoplastic elastomer compositions in order to deliver specific ingredients to the desired location during the reactive extrusion process, such as the stannous chloride powder. The reinforcing fillers can be added as a single batch or as a multiple mixing batch added at different time of the blending process.

The process oil may be present in the thermoplastic elastomer composition, before and/or after the curing process, at 10-100 phr, 15-75 phr, or 20-50 phr. The process oil may be present in the thermoplastic elastomer composition, before the curing process, at 10-100 phr, 15-75 phr, 20-50 phr, 20-80 phr, 30-70 phr, or 40-60 phr. The process oil may be present in the thermoplastic elastomer composition, after the curing process, at 10-100 phr, 15-75 phr, 20-50 phr, 10-30 phr, or 15-25 phr.

Process oil may be an oil comprising a polyisobutene (PIB) polymer (any suitable examples of PIB polymer, used as a processing aid due to its miscibility with BIMSMs, such as with the EXXPRO™ polymers (available from ExxonMobil Chemical, Baytown, Texas), and its acceptance in the pharmaceutical applications where other oils and plasticizers are not typically allowed. Examples of PIB may include INDOPOL™ H100 (available from INEOS Oligomers USA LLC, League City, Texas). Preferred PIB polymers have a specific gravity of 0.75 to 1; a kinematic viscosity at 100° C. (Kvioo) of 50 mm²/s to 3000 mm²/s (50 cSt to 3000 cSt), or 60 mm²/s to 2900 mm²/s (70 cSt to 2700 cSt), or 70 mm²/s to 2800 mm²/s (70 cSt to 2700 cSt).

Typical properties of INDOPOL™ H100 are as follows:

| Typical Properties | Method/ASTM number | Value |
|---|---|---|
| Molecular Weight, Mn | Gel Permeation | 910 |
| | Chromatography/modified D5296 | |
| Polydispersity | Gel Permeation | 1.60 |
| Index, Mw/Mn | Chromatography/modified D5296 | |
| Flash Point (° C.) | Cleveland Open Cup/D92 | >210 |
| Turbidity (NTU) | Nephelometry/n/a | <4 |
| Acid Number | Color-Indicator Titration/D974 | <0.05 |
| (mg KOH/g) | | |
| Bromine Number | Color-Indicator Titration/IP | 16.5 |
| (g Br₂/100 g) | 129/87 | |
| Chlorine (ppm) | X-Ray Fluorescence/n/a | 40 |
| Metals (ppm): | Inductively Coupled Plasma | |
| | Spectrometry/n/a | |
| Na | | <1 |
| K | | <1 |
| Fe | | <1 |
| Specific Gravity | Hydrometer/D1298 | 0.893 |
| (15.5° C.) | | |
| Glass Transition | Differential Scanning | −69.6 |
| Temperature, Tg (° C.) | Calorimetry/n/a | |
| Pour Point (° C.) | D97 | −7 |
| Viscosity Index | D2270 | 125 |
| Refractive Index | D1218 | 1.494 |
| Total Sulfur (ppm) | X-Ray Fluorescence/n/a | <5 |

The thermoplastic elastomer compositions described herein may also include additives that may include, but are not limited to, curatives, crosslinking agents, plasticizers, compatibilizers, and the like, and any combination thereof.

Metal oxide compounds may be present in the thermoplastic elastomer compositions. In at least one embodiment, the metal oxide is selected from magnesium oxide (MgO), zinc oxide (ZnO), manganese oxide (MnO), sodium oxide (Na₂O), iron oxide (Fe₂O₃), silicon dioxide (SiO₂), calcium oxide (CaO), aluminum oxide (Al₂O₃), or a mixture thereof

Suitable vulcanization activators include zinc oxide (also referred to as “ZnO”), stearic acid, and the like. These activators may be mixed in amounts ranging from 0.1 phr to 50 phr. Different vulcanization activators may be present in different amounts. For instance, where the vulcanization activator includes zinc oxide, the zinc oxide may be present in an amount from 0 phr to 20 phr, such as 0 phr to 10 phr, such as 0 phr to 5 phr, such as 0 phr to 2 phr, while stearic acid may preferably be employed in amounts ranging from 0.05 phr to 15 phr, such as from 0.1 phr to 10 phr, such as about 1 phr, for example).

Further additives may be chosen from any known additives useful for thermoplastic elastomeric compositions, and include, among others, one or more of:
Vulcanization accelerators: compositions of the present disclosure can comprise 0.1-15 phr, 1-10 phr, or 2-5 phr, with examples including thiazoles such as 2-mercaptobenzothiazole or mercaptobenzothiazyl disulfide (MBTS); guanidines such as diphenylguanidine; sulfenamides such as N-cyclohexylbenzothiazolsulfenamide; dithiocarbamates such as zinc dimethyl dithiocarbamate, zinc diethyl dithiocarbamate, zinc dibenzyl dithiocarbamate (ZBEC); and zinc dibutyldithiocarbamate, thioureas such as 1,3-diethylthiourea, thiophosphates and others;
Processing aids (e.g., polyethylene glycol);
Where foaming may be desired, sponge or foaming grade additives, such as foaming agent or blowing agent, particularly in very high Mooney viscosity embodiments, such as those suitable for sponge grades. Examples of such agents include: azodicarbonamide (ADC), ortho-benzo sulfonyl hydrazide (OBSH), p-toluenesulfonylhydrazide (TSH), 5-phenyltetrazole (5-PT), and sodium bicarbonate in citric acid. Microcapsules may also or instead be used for such foaming applications. These may include a thermo-expandable microsphere comprising a polymer shell with a propellant contained therein. Suitable examples are described in U.S. Pat. Nos. 6,582,633 and 3,615,972, WIPO Publication Nos. WO 99/46320 and WO 99/43758, and contents of which hereby are incorporated by reference. Examples of such thermo-expandable microspheres include EXPANCEL™ products commercially available from Akzo Nobel N.V., and ADVANCELL™ products available from Sekisui. In other embodiments, sponging or foaming may be accomplished by direct injection of gas and/or liquid (e.g., water, CO₂, N₂) into the rubber in an extruder, for foaming after passing the composition through a die; and
Various other additives may also be included, such as antioxidants (e.g., 1,2-dihydro-2,2,4-trimethylquinoline; SANTOFLEX® 6PPD), wax antiozonant (e.g., NOCHEK® 4756A), stabilizers, anticorrosion agents, UV absorbers, antistatics, slip agents, moisture absorbents (e.g., calcium oxide), pigments, dyes or other colorants.

Thermoplastic elastomer compositions of the present disclosure may be formed by combining the thermoplastic phase, the BIMSM, the curing agents, the processing oil, and additional additives, as needed, using any suitable method known in the polymer processing art. For example, a thermoplastic elastomer composition may be made by blending the thermoplastic phase, the BIMSM, the curing agents, the processing oil, and additional additives, as needed, in the melt state. The components of the blend may be blended in any order. For instance, the blending process may be an in situ-blending process carried out in any reactor suitable for the said process. Thus, the blending can be a Twin Screw Extrusion (TSE) blending, or a batch mixing (e.g., BANBURY™), for example.

In at least one instance, a method for preparing a thermoplastic elastomer composition of the PPH and the BIMSM includes contacting in a first reactor a Ziegler-Natta catalyst with propene monomers to form a PPH polymer described herein. For purpose of the present disclosure, any commercially available PPH can be used. The method further includes preparing BIMSM (either commercially available or formed in situ by using any suitable method for BIMSM production). Methods can include transferring the PPH to the second reactor or the BIMSM to the first reactor and recovering from the second reactor or the first reactor, respectively, a mixture of the PPH and the BIMSM. The recovered thermoplastic elastomer composition may then be crosslinked, for example, as described in more detail below.

The blend may be prepared by combining the thermoplastic phase, the BIMSM, for example, in a twin-screw extruder.

In another example, the method of blending the rubber polymers including thermoplastic phase and BIMSM may be to melt-blend the polymers in a batch mixer, such as a BANBURY™ or BARBENDER™ mixer. Blending may include melt blending the thermoplastic phase, the BIMSM in an extruder, such as a single-screw extruder or a twin-screw extruder. Suitable examples of extrusion technology for polymer blends can be described in more detail in PLASTICS EXTRUSION TECHNOLOGY, F. Hensen, Ed. (Hanser, 1988), pp. 26-37, and in POLYPROPYLENE HANDBOOK, E. P. Moore, Jr. Ed. (Hanser, 1996), pp. 304-348.

The thermoplastic phase and the BIMSM may also be blended by a combination of methods including, but not limited to, solution blending, melt mixing, compounding in a shear mixer and combinations thereof. For example, dry blending followed by melt blending in an extruder, or batch mixing of some components followed by melt blending with other components in an extruder. The thermoplastic phase and the BIMSM may also be blended using a double-cone blender, ribbon blender, or other suitable blender, or in a FARREL CONTINUOUS MIXER™ (FCM™).

The thermoplastic phase, the BIMSM, the curatives, the processing oil, and optionally additional additives (e.g., reinforcing fillers, crosslinking agents (or crosslinkers), plasticizers, compatibilizers, and the like) may be blended in varying orders, which in some instances may alter the properties of the resultant composition.

For example, a master batch that comprises the thermoplastic phase and the BIMSM and additives (except curatives and crosslinking agents) may be produced at a first temperature.

Then, the curatives and/or crosslinking agents may be mixed into the master batch at a second temperature that is lower than the first temperature.

In another example, the master batch may be produced by mixing together in one-step the thermoplastic phase and the BIMSM and the additives (except curatives and crosslinking agents) until the additives are incorporated (e.g., producing a homogeneous blend). This is referred to herein as a first pass method or first pass blending. After the first pass blending produces the master batch, the curatives and/or crosslinking agents may be mixed into the master batch to produce the final blend.

In yet another example, a two-step mixing process may be used to produce the master batch. For example, the master batch may be produced by mixing the BIMSM with the additives (except curatives and crosslinking agents) until the additives are incorporated into the BIMSM (e.g., producing a homogeneous blend). Then, the resultant blend is mixed with the thermoplastic phase and the curatives and/or crosslinking agents. This is referred to herein as a second pass method or a second pass blending. Alternatively, the curatives and/or crosslinking agents may be mixed into the master batch after addition of the BIMSM in the second pass to produce the final blend.

In some second pass blendings, mixing the BIMSM/additive (except curatives and crosslinking agents) blend with the thermoplastic phase may be done in mixer or other suitable system without removing the BIMSM/additive blend from the mixer (i.e., first pass blending) to produce the master batch. Alternatively, the BIMSM/additive (except curatives and crosslinking agents) blend may be removed from a mixer or other suitable system for producing the blend, and, then, mixed with the thermoplastic phase in a mixer or other suitable system (i.e., second pass blending) to produce the master batch.

For example, method for preparing a thermoplastic elastomer composition of the thermoplastic phase, the BIMSM, and one or more reinforcing fillers includes mixing one or more reinforcing fillers through at least a two stages of mixing. For example, when the reinforcing filler is a mineral filler (e.g., clay), the clay-filled thermoplastic elastomer composition may go through two stages of mixing.

In embodiments where curatives (e.g., crosslinking agents or vulcanizing agents) are present in a thermoplastic elastomer composition, the thermoplastic phases and BIMSMs of the thermoplastic elastomer composition may be present in at least partially crosslinked form (that is, at least a portion of the polymer chains are crosslinked with each other, e.g., as a result of a curing process). Accordingly, particular embodiments provide for an at least partially crosslinked rubber composition made by mixing (in accordance with any of the above-described methods for polymer blends) a thermoplastic elastomer composition comprising: (a) BIMSM; (b) a thermoplastic phase (10 phr to 50 phr); (c) reinforcing fillers; (d) vulcanization activators, vulcanizing agents, and/or crosslinking agents; and optionally (e) further additives.

The thermoplastic elastomer compositions described herein (e.g., comprising thermoplastic phase, the BIMSM, the curing agents, the processing oil, and optionally additional additives) may have a specific gravity at about 23° C. of from 0.8 g/cm³ to 1 g/cm³, or 0.85 g/cm³ to 1, 0.90 g/cm³ to 0.98 g/cm³, 0.92 g/cm³ to 0.98 g/cm³.

The thermoplastic elastomer compositions described herein (e.g., comprising thermoplastic phase, the BIMSM, the curing agents, the processing oil, and optionally additional additives) may have a moisture vapor (%) of from 0.01-0.03%, 0.012-0.028%, 0.014-0.026%, or 0.020-0.026%.

The thermoplastic elastomer compositions described herein (e.g., comprising thermoplastic phase, the BIMSM, the curing agents, the processing oil, and optionally additional additives) may have an extrusion surface Ra (μall) of from 140-190 μm, 145-180 μm, or 150-170 μm.

The thermoplastic elastomer compositions described herein (e.g., comprising thermoplastic phase, the BIMSM, the curing agents, the processing oil, and optionally additional additives) may have a Tensile Strength (MPa) of from 1-10 MPa, 2-8 MPa, or 4-6 MPa.

The thermoplastic elastomer compositions described herein (e.g., comprising thermoplastic phase, the BIMSM, the curing agents, the processing oil, and optionally additional additives) may have a 100% Modulus (MPa) of from 1-5 MPa, 1.2-4.8 MPa, 1.4-4.6 MPa, or 1.6-4.4 MPa.

The thermoplastic elastomer compositions described herein (e.g., comprising thermoplastic phase, the BIMSM, the curing agents, the processing oil, and optionally additional additives) may have an elongation at break (%) of from 100% to 500%, or 120% to 450%, or 140% to 425%, or 160% to 400%.

The thermoplastic elastomer compositions described herein (e.g., comprising thermoplastic phase, the BIMSM, the curing agents, the processing oil, and optionally additional additives) may have a permeability (cc.mm/m²·day.mmHg) of from 0.1 cc mm/m²·day mmHg to 1 cc mm/m²·day mmHg, or 0.2 cc mm/m²·day mmHg to 0.8 cc mm/m²·day mmHg, or 0.4 cc mm/m²·day mmHg to 0.6 cc mm/m²·day mmHg.

The thermoplastic elastomer compositions described herein (e.g., comprising thermoplastic phase, the BIMSM, the curing agents, the processing oil, and optionally additional additives) may have a punch force (maximum force (N) out of 10 punctures) of from 1 to 10.

The thermoplastic elastomer compositions described herein (e.g., comprising thermoplastic phase, the BIMSM, the curing agents, the processing oil, and optionally additional additives) may have a fragmentation capability number of fragmented particles out of 48 punctures across 12 vials) of from 1-15.

The thermoplastic elastomer compositions described herein (e.g., comprising thermoplastic phase, the BIMSM, the curing agents, the processing oil, and optionally additional additives) may have a hardness (Shore A) of 40-90, 42-80, or 44-70, alternatively from 30-60, 35-55, or 40-50.

### Brominated Isobutylene Paramethyl-Styrene Terpolymers

Thermoplastic elastomer compositions described herein comprise one or more BIMSMs.

The BIMSM of the present disclosure may have a Mooney viscosity (ML 1+8, 125° C.) of 30 MU to 50 MU, according to the ASTM D1646 test method.

The BIMSM of the present disclosure may have a benzylic bromine content of 0.3 mol % to 5 mol %, or 0.5 mol % to 4.5 mol %, or 1 mol % to 4 mol %, or 1.5 mol % to 3.5 mol %.

The BIMSM of the present disclosure may have a calcium content of 0.01 wt % to 0.5 wt %, or 0.02 wt % to 0.25 wt %, or 0.03 wt % to 0.20 wt %, or 0.04 wt % to 0.15 wt %, based on the total weight percent of the BIMSM.

The BIMSM of the present disclosure may have a water content of 0.01 wt % to 0.5 wt %, or 0.02 wt % to 0.4 wt %, or 0.03 wt % to 0.3 wt %, based on the total weight percent of the BIMSM.

The BIMSM may be used as a solution polymerized BIMSM or as an emulsion polymerized BIMSM when produced by solution polymerization, or emulsion polymerization, respectively.

Suitable examples of BIMSM may include EXXPRO™ 3745, EXXPRO™ 3433, EXXPRO™ 3563, and EXXPRO™ 3035 (all EXXPRO™ brominated isobutylene paramethyl -styrene terpolymers manufactured by ExxonMobil Chemical, Baytown, Texas). For example, EXXPRO™ 3745 can be used in the thermoplastic elastomer composition and has a Mooney viscosity (ML 1+8, 125° C.) of 40 MU to 50 MU, according to the ASTM D1646 test method; a benzylic bromine content of 1.1 mol % to 1.3 mol %, a calcium content of 0.07 wt % to 0.11 wt %, based on the total weight percent of the BIMSM, and a water content of 0.3 wt %, based on the total weight percent of the BIMSM.

In some embodiments, where butyl rubber includes isobutylene paramethyl-styrene copolymer, the copolymer may include a paramethyl-styrene content of about 0.5 wt % to about 25 wt %, or about 2 wt % to about 20 wt %, based on the total weight of the copolymer with the remainder being isobutylene.

Thermoplastic elastomer compositions described herein can comprise a single BIMSM or a mixture of two or more BIMSMs, it being possible for the BIMSM to be used in combination with any type of synthetic elastomer other than an BIMSM, indeed even with polymers other than elastomers, for example thermoplastic polymers.

### Thermoplastic Polyolefin

In the present thermoplastic elastomer compositions, the thermoplastic polyolefin comprises a propylene-based thermoplastic polymer, an ethylene-based thermoplastic polymer, or other suitable polyolefin-based thermoplastic polymers. The major component of such propylene-based, ethylene-based, or other suitable polyolefin-based polymers may be homopolymers, random copolymers, impact copolymers, or combination thereof In certain embodiments the thermoplastic matrix of the thermoplastic elastomer composition is a blend of two different thermoplastic polyolefins (e.g., polypropylene and polyethylene). In certain embodiments the thermoplastic polyolefin matrix of the thermoplastic elastomer composition is a blend of a thermoplastic polyolefins and a soft thermoplastic elastomer (e.g., polypropylene and polyethylene). The subsequent embodiment details the different components used in the thermoplastic phase.

### 1. Propylene-Based Polymers

Propylene-based polymers include those solid, generally high molecular weight plastic resins that primarily include units deriving from the polymerization of propylene. In some embodiments at least 75%, in other embodiments at least 90%, in other embodiments at least 95%, and in other embodiments at least 97% of the units of the propylene-based polymer can derive from the polymerization of propylene. In particular embodiments, these polymers include homopolymers of propylene. Homopolymer polypropylene can include linear chains and/or chains with long chain branching.

In some embodiments, the propylene-based polymers can include units deriving from the polymerization of ethylene and/or α-olefins such as 1-butene, 1-hexene, 1-octene, 2-methyl-1-propene, 3-methyl-1-pentene, 4-methyl-1-pentene, 5-methyl-1-hexene, and mixtures thereof. Specifically included are the reactor, impact, and random copolymers of propylene with ethylene or the higher α-olefins, such as with C4-C40 α-olefins, such as C5-C20 α-olefins, such as C6-C10 α-olefins.

In some embodiments, the propylene-based polymer can include one or more of the following characteristics:

The propylene-based polymers can include semi-crystalline polymers. In some embodiments, these polymers can be characterized by a crystallinity of at least about 25 wt % or more, such as about 55 wt % or more, such as about 65 wt % or more, such as about 70 wt % or more. Crystallinity can be determined by dividing the heat of fusion (Hf) of a sample by the heat of fusion of a 100% crystalline polymer, which is assumed to be 209 joules/gram for polypropylene.

The propylene-based polymers can have an Hf of about 52.3 J/g or more, such as about 100 J/g or more, such as about 125 J/g or more, such as about 140 J/g or more, as measured by ASTM D3418.

The propylene-based polymers can have a weight average molecular weight (Mw) of from about 50,000 g/mol to about 2,000,000 g/mol, such as from about 100,000 g/mol to about 1,000,000 g/mol, such as from about 100,000 g/mol to about 600,000 g/mol or from about 400,000 g/mol to about 800,000 g/mol, as measured by GPC with polystyrene standards.

The propylene-based polymers can have a number average molecular weight (Mn) of from about 25,000 g/mol to about 1,000,000 g/mol, such as from about 50,000 g/mol to about 300,000 g/mol, as measured by GPC with polystyrene standards.

The propylene-based polymers can have a g′ vis that of about 1 or less, such as about 0.9 or less, such as about 0.8 or less, such as about 0.6 or less, such as about 0.5 or less, as measured by GPC procedure described below.

The propylene-based polymers can have a melt mass flow rate (MFR) (ASTM D1238, 2.16 kg weight @ 230° C.) of about 0.1 g/10 min or more, such as about 0.2 g/10 min or more, such as about 0.25 g/10 min or more. Alternatively, the MFR can be from about 0.1 g/10 min to about 1500 g/10 min, such as from about 0.5 g/10 min to about 1000 g/10 min, such as from about 0.5 g/10 min to about 900 g/10 min.

The propylene-based polymers can have a melt temperature (Tm) of from about 110° C. to about 170° C., such as from about 140° C. to about 168° C., such as from about 160° C. to about 165° C., as measured by ASTM D3418.

The propylene-based polymers can have a glass transition temperature (Tg) of from about -50° C. to about 10° C., such as from about -30° C. to about 5° C., such as from about -20° C. to about 2° C., as measured by ASTM D3418.

The propylene-based polymers can have a crystallization temperature (Tc) of about 75° C. or more, such as about 95° C. or more, such as about 100° C. or more, such as about 105° C. or more, such as from about 105° C. to about 130° C., as measured by ASTM D3418.

In some embodiments, the propylene-based polymers can include a homopolymer of a high-crystallinity isotactic or syndiotactic polypropylene. This polypropylene can have a density of from about 0.89 to about 0.91 g/ml, with the largely isotactic polypropylene having a density of from about 0.90 to about 0.91 g/ml. Also, high and ultra-high molecular weight polypropylene that has a fractional melt flow rate can be employed. In some embodiments, polypropylene resins can be characterized by a MFR (ASTM D-1238; 2.16 kg @ 230° C.) that can be about 10 dg/min or less, such as about 1.0 dg/min or less, such as about 0.5 dg/min or less.

In some embodiments, the polypropylene includes a homopolymer, random copolymer, or impact copolymer polypropylene or combination thereof. In some embodiments, the polypropylene is a high melt strength (HMS) long chain branched (LCB) homopolymer polypropylene.

The propylene-based polymers can be synthesized by using an appropriate polymerization technique known in the art such as the conventional Ziegler-Natta type polymerizations, and catalysis employing single-site organometallic catalysts including metallocene catalysts.

Examples of polypropylene useful for the TPV compositions described herein include random copolymer polypropylene such as, ExxonMobil™ PP9513, Braskem™ F180A (available from Braskem), ExxonMobil™ PP3155E5, ExxonMobil™ PP9122, homopolymer PP, such as, Achieve™ Advanced PP6936G2, ExxonMobil™ PP5341 (available from ExxonMobil); Achieve™ PP6282NE1 (available from ExxonMobil) and/or polypropylene resins with broad molecular weight distribution as described in U.S. Pat. No. 9,453,093 and U.S. Pat. No. 9,464,178; and other polypropylene resins described in US20180016414 and US20180051160; Waymax MFX6 (available from Japan Polypropylene Corp.); Borealis Daploy™ WB140 (available from Borealis AG); and Braskem Ampleo 1025MA and Braskem Ampleo 1020GA (available from Braskem Ampleo), impact copolymer polypropylene such as, Achieve™ Advanced PP8285E1, ExxonMobil™ PP8255E1, and, ExxonMobil™ PP8244E1 and, other suitable polypropylenes.

In one or more embodiments, the thermoplastic component can include isotactic polypropylene. In some embodiments, the thermoplastic component can contain one or more crystalline propylene homopolymers or copolymers of propylene having a melting temperature of from about 110° C. to about 170° C. or higher as measured by DSC. Example copolymers of propylene can include terpolymers of propylene, impact copolymers of propylene, random polypropylene and mixtures thereof. Example comonomers can have about 2 carbon atoms or from about 4 to about 12 carbon atoms. In some embodiments, the comonomer can be ethylene.

The term “random polypropylene” as used herein broadly means a single phase copolymer of propylene having up to about 9 wt %, such as from about 2 wt % to about 8 wt % of an alpha olefin comonomer. Example alpha olefin comonomers can have about 2 carbon atoms or from about 4 to about 12 carbon atoms. In some embodiments, the alpha olefin comonomer can be ethylene.

In one or more embodiments, the thermoplastic resin component can be or include a “propylene-based copolymer.” A “propylene-based copolymer” includes at least two different types of monomer units, one of which is propylene. Suitable monomer units can include ethylene and higher alphα-olefins ranging from C4 to C20, such as, for example, 1-butene, 4-methyl-1-pentene, 1-hexene, 1-octene, 1-decene, or mixtures thereof. In some embodiments, ethylene can be copolymerized with propylene, so that the propylene-based copolymer includes propylene-derived units (units on the polymer chain derived from propylene monomers) and ethylene-derived units (units on the polymer chain derived from ethylene monomers).

### 2. Polypropylene Homopolymers

Thermoplastic elastomer compositions described herein may comprise: 10 phr to 50 phr (or 12.5 phr to 47.5 phr, or 15 phr to 45 phr, or 17.5 phr to 42.5 phr, or 20 phr to 40 phr) of a PPH having a melt flow rate (MFR) (230° C./2.16 kg) of 0.2 g/10 min to 2000 g/10 min (or 0.5 g/10 min to 1500 g/10 min, or 0.5 g/10 min to 1000 g/10 min, or 0.5 g/10 min to 500 g/10 min, or 0.5 g/10 min to 100 g/10 min, more preferably 0.5 g/10 min to 20 g/10 min), based on the ASTM D1238 test method).

Thermoplastic elastomer compositions described herein can comprise a single PPH or a mixture of two or more PPH (e.g., a dual reactor product or blended PPHs).

The PPH may be a linear or branched homopolymer of a propylene monomer. Alternatively, the polypropylene may be a polypropylene copolymer produced from propylene and one or more comonomers at a mol ratio of a pentene to the comonomers (cumulatively) of 1:1 to 500:1 (or 5:1 to 250:1, 1:1 to 100:1, 1:1 to 10:1, 5:1 to 50:1, 50:1 to 250:1, or 100:1 to 500:1). For example, polypropylene polymers can be propylene homopolymers or propylene copolymers, such as propylene-ethylene and/or propylene-alphaolefin (preferably C3 to C20) copolymers (such as propylene-hexene copolymers or propylene-octene copolymers) having: a Mw/Mn of greater than 1 to 4 (preferably greater than 1 to 3).

Monomers of propylene can be contacted with a catalyst system comprising an activator and at least one catalyst compound, such as a metallocene or Zielger-Natta catalyst compound. The catalyst compound and activator may be combined in any order, and are combined typically prior to contacting with the monomer. The catalyst system may comprise an inert support material. Preferably the supported material is a porous support material, for example, talc, and inorganic oxides. Other support materials include zeolites, clays, organoclays, or any other organic or inorganic support material and the like, or mixtures thereof.

Preferably, the support material is an inorganic oxide in a finely divided form. Suitable inorganic oxide materials for use in catalyst systems herein include Groups 2, 4, 13, and 14 metal oxides, such as silica, alumina, and mixtures thereof. Other inorganic oxides that may be employed either alone or in combination with the silica, or alumina are magnesia, titania, zirconia, and the like. Other suitable support materials, however, can be employed, for example, finely divided functionalized polyolefins, such as finely divided polypropylene. Particularly useful supports include magnesia, titania, zirconia, montmorillonite, phyllosilicate, zeolites, talc, clays, and the like. Also, combinations of these support materials may be used, for example, silica-chromium, silica-alumina, silica-titania, and the like. Preferred support materials include Al₂O₃, ZrO₂, SiO₂, and combinations thereof, more preferably SiO₂, Al₂O₃, or SiO₂/Al₂O₃.

It is preferred that the support material, most preferably an inorganic oxide, has a surface area in the range of from about 10 to about 700 m²/g, pore volume in the range of from about 0.1 to about 4.0 cc/g and average particle size in the range of from about 5 to about 500

More preferably, the surface area of the support material is in the range of from about 50 to about 500 m²/g, pore volume of from about 0.5 to about 3.5 cc/g and average particle size of from about 10 to about 200 Most preferably the surface area of the support material is in the range is from about 100 to about 400 m²/g, pore volume from about 0.8 to about 3.0 cc/g and average particle size is from about 5 to about 100 The average pore size of the support material useful in the invention is in the range of from 10 to 1000 A, preferably 50 to about 500 A, and most preferably 75 to about 350 A. In some embodiments, the support material is a high surface area, amorphous silica (surface area=300 m²/gm; pore volume of 1.65 cm³/gm).

Preferred silicas are marketed under the tradenames of Davison™ 952 or Davison™ 955 by the Davison Chemical Division of W. R. Grace and Company. In other embodiments DAVISON™ 948 is used.

The support material should be dry, that is, free of absorbed water. Drying of the support material can be effected by heating or calcining at about 100° C. to about 1000° C., preferably at least about 600° C. When the support material is silica, it is heated to at least 200° C., preferably about 200° C. to about 850° C., and most preferably at about 600° C.; and for a time of about 1 minute to about 100 hours, from about 12 hours to about 72 hours, or from about 24 hours to about 60 hours. The calcined support material must have at least some reactive hydroxyl (OH) groups to produce supported catalyst systems of this invention. The calcined support material is then contacted with at least one polymerization catalyst comprising at least one catalyst compound and an activator.

The support material, having reactive surface groups, typically hydroxyl groups, is slurried in a non-polar solvent and the resulting slurry is contacted with a solution of a catalyst compound and an activator. In some embodiments, the slurry of the support material is first contacted with the activator for a period of time in the range of from about 0.5 hours to about 24 hours, from about 2 hours to about 16 hours, or from about 4 hours to about 8 hours. The solution of the catalyst compound is then contacted with the isolated support/activator. In some embodiments, the supported catalyst system is generated in situ. In alternate embodiment, the slurry of the support material is first contacted with the catalyst compound for a period of time in the range of from about 0.5 hours to about 24 hours, from about 2 hours to about 16 hours, or from about 4 hours to about 8 hours. The slurry of the supported catalyst compound is then contacted with the activator solution.

The mixture of the catalyst, activator and support is heated to about 0° C. to about 70° C., preferably to about 23° C. to about 60° C., preferably at room temperature. Contact times typically range from about 0.5 hours to about 24 hours, from about 2 hours to about 16 hours, or from about 4 hours to about 8 hours.

Suitable non-polar solvents are materials in which all of the reactants used herein, i.e., the activator, and the catalyst compound, are at least partially soluble and which are liquid at reaction temperatures. Preferred non-polar solvents are alkanes, such as isopentane, hexane, n-heptane, octane, nonane, and decane, although a variety of other materials including cycloalkanes, such as cyclohexane, aromatics, such as benzene, toluene, and ethylbenzene, may also be employed.

The propylene polymer may comprise propylene and an optional comonomers comprising one or more ethylene or C₄ to C₄₀ olefins, preferably C₄ to C₂₀ olefins, or preferably C₆ to C₁₂ olefins. The C₄ to C₄₀ olefin monomers may be linear, branched, or cyclic. The C₄ to C₄₀ cyclic olefins may be strained or unstrained, monocyclic or polycyclic, and may optionally include heteroatoms and/or one or more functional groups.

Polymerization processes for making PPH can be carried out in any manner known in the art. Any suspension, homogeneous, bulk, solution, slurry, or gas phase polymerization process known in the art can be used. Such processes can be run in a batch, semi-batch, or continuous mode. Homogeneous polymerization processes and slurry processes are preferred.

(A homogeneous polymerization process is defined to be a process where at least 90 wt % of the product is soluble in the reaction media.) A bulk homogeneous process is particularly preferred. (A bulk process is defined to be a process where monomer concentration in all feeds to the reactor is 70 volume % or more.) Alternately, no solvent or diluent is present or added in the reaction medium, (except for the small amounts used as the carrier for the catalyst system or other additives, or amounts typically found with the monomer; e.g., propane in propylene). In another embodiment, the process is a slurry process. As used herein the term “slurry polymerization process” means a polymerization process where a supported catalyst is employed and monomers are polymerized on the supported catalyst particles. At least 95 wt % of polymer products derived from the supported catalyst are in granular form as solid particles (not dissolved in the diluent).

Suitable diluents/solvents for polymerization include non-coordinating, inert liquids. Examples include straight and branched-chain hydrocarbons, such as isobutane, butane, pentane, isopentane, hexanes, isohexane, heptane, octane, dodecane, and mixtures thereof cyclic and alicyclic hydrocarbons, such as cyclohexane, cycloheptane, methylcyclohexane, methylcycloheptane, and mixtures thereof, such as can be found commercially (Isopar™ fluids); perhalogenated hydrocarbons, such as perfluorinated C₄-C₁₀ alkanes, chlorobenzene, and aromatic and alkylsubstituted aromatic compounds, such as benzene, toluene, mesitylene, and xylene. Suitable solvents also include liquid olefins which may act as monomers or comonomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the solvent is not aromatic, preferably aromatics are present in the solvent at less than 1 wt %, preferably less than 0.5 wt %, preferably less than 0 wt % based upon the weight of the solvents.

In at least one embodiment, the feed concentration of the monomers and comonomers for the polymerization is 60 vol % solvent or less, preferably 40 vol % or less, or preferably 20 vol % or less, based on the total volume of the feedstream. Preferably the polymerization is run in a bulk process.

Preferred polymerizations can be run at any temperature and/or pressure suitable to obtain the desired propylene polymers. Typical temperatures and/or pressures include a temperature in the range of from about 0° C. to about 300° C., preferably about 20° C. to about 200° C., preferably about 35° C. to about 150° C., preferably from about 40° C. to about 120° C., preferably from about 45° C. to about 80° C.; and at a pressure in the range of from about 0.35 MPa to about 10 MPa, preferably from about 0.45 MPa to about 6 MPa, or preferably from about 0.5 MPa to about 4 MPa.

In a typical polymerization, the run time of the reaction is up to 300 minutes, preferably in the range of from about 5 to 250 minutes, or preferably from about 10 to 120 minutes.

Hydrogen can be present in the polymerization reactor at a partial pressure of 0.001 to 50 psig (0.007 to 345 kPa), preferably from 0.01 to 25 psig (0.07 to 172 kPa), more preferably 0.1 to 10 psig (0.7 to 70 kPa).

Little or no alumoxane may be used in the process to produce the polymers. Preferably, alumoxane may be present at zero mol %, alternately the alumoxane may be present at a molar ratio of aluminum to transition metal less than 500:1, preferably less than 300:1, preferably less than 100:1, preferably less than 1:1.

Furthermore, little or no scavenger may be used in the process to produce the propylene polymer. Preferably, scavenger (such as tri alkyl aluminum) may be present at zero mol %, alternately the scavenger may be present at a molar ratio of scavenger metal to transition metal of less than 100:1, preferably less than 50:1, preferably less than 15:1, preferably less than 10:1.

In at least one embodiment, the polymerization: 1) is conducted at temperatures of 0 to 300° C. (preferably 25° C. to 150° C., preferably 40° C. to 120° C., preferably 45° C. to 80° C.); 2) is conducted at a pressure of atmospheric pressure to 10 MPa (preferably 0.35 to 10 MPa, preferably from 0.45 to 6 MPa, preferably from 0.5 to 4 MPa); 3) is conducted in an aliphatic hydrocarbon solvent (such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof; preferably where aromatics are preferably present in the solvent at less than 1 wt %, preferably less than 0.5 wt %, preferably at 0 wt % based upon the weight of the solvents); 4) wherein the catalyst system used in the polymerization comprises less than 0.5 mol %, preferably 0 mol % alumoxane, alternately the alumoxane is present at a molar ratio of aluminum to transition metal less than 500:1, preferably less than 300:1, preferably less than 100:1, preferably less than 1:1; 5) the polymerization preferably occurs in one reaction zone; 6) the productivity of the catalyst compound is at least 80,000 g/mmol/hr (preferably at least 150,000 g/mmol/hr, preferably at least 200,000 g/mmol/hr, preferably at least 250,000 g/mmol/hr, preferably at least 300,000 g/mmol/hr); 7) optionally scavengers (such as trialkyl aluminum compounds) are absent (e.g. present at zero mol %, alternately the scavenger is present at a molar ratio of scavenger metal to transition metal of less than 100:1, preferably less than 50:1, preferably less than 15:1, preferably less than 10:1); and 8) optionally hydrogen is present in the polymerization reactor at a partial pressure of 0.001 to 50 psig (0.007 to 345 kPa) (preferably from 0.01 to 25 psig (0.07 to 172 kPa), more preferably 0.1 to 10 psig (0.7 to 70 kPa)). In a preferred embodiment, the catalyst system used in the polymerization comprises no more than one catalyst compound. A “reaction zone” also referred to as a “polymerization zone” is a vessel where polymerization takes place, for example a batch reactor. When multiple reactors are used in either series or parallel configuration, each reactor is considered as a separate polymerization zone. For a multi-stage polymerization in both a batch reactor and a continuous reactor, each polymerization stage is considered as a separate polymerization zone. In a preferred embodiment, the polymerization occurs in one reaction zone. Room temperature is 23° C. unless otherwise noted.

Other additives may also be used in the polymerization, as desired, such as one or more scavengers, promoters, modifiers, reducing agents, oxidizing agents, hydrogen, aluminum alkyls, silanes, or chain transfer agents (such as alkylalumoxanes, a compound represented by the formula AlR₃ or ZnR₂ (where each R is, independently, a C₁ to C₈ aliphatic radical, preferably methyl, ethyl, propyl, butyl, pentyl, hexyl, octyl or an isomer thereof) or a combination thereof, such as diethyl zinc, methylalumoxane, trimethylaluminum, triisobutylaluminum, trioctylaluminum, or a combination thereof).

The PPHs of the present disclosure may have a melt flow rate (MFR) (230° C./2.16 kg) of 0.2 g/10 min to 2000 g/10 min (or 0.5 g/10 min to 1500 g/10 min, or 0.5 g/10 min to 1000 g/10 min, or 0.5 g/10 min to 500 g/10 min, or 0.5 g/10 min to 100 g/10 min, more preferably 0.5 g/10 min to 20 g/10 min), based on the ASTM D1238 test method).

### 3. Ethylene-Based Thermoplastic Polymer

Ethylene-based thermoplastic polymers include those solid, such as high-molecular weight plastic resins, that primarily comprise units deriving from the polymerization of ethylene. In some embodiments, at least 90%, in other embodiments at least 95%, and in other embodiments at least 99% of the units of the ethylene-based polymer derive from the polymerization of ethylene. In particular embodiments, these polymers include homopolymers of ethylene.

In some embodiments, the ethylene-based polymers may also include units deriving from the polymerization of α-olefins such as propylene, 1-butene, 1-hexene, 1-octene, 2-methyl-1-propene, 3-methyl-1-pentene, 4-methyl-1-pentene, 5-methyl-1-hexene, and mixtures thereof.

In some embodiments, the ethylene-based polymer includes one, more, or all of the following characteristics:

1) A melt index (MI) (ASTM D-1238, 2.16 kg@190° C.) that is from about 0.1 dg/min to about 1,000 dg/min, such as from about 1.0 dg/min to about 200 dg/min or from about 7.0 dg/min to about 20.0 dg/min.

2) A melt temperature (Tm) that is from about 140° C. to about 90° C., such as from about 135° C. to about 125° C. or from about 130° C. to about 120° C.).

3) A density greater than 0.90 g/cm3.

The ethylene-based polymers may be synthesized by using an appropriate polymerization technique known in the art such as the conventional Ziegler-Natta type polymerizations, and catalysis employing single-site organometallic catalysts including metallocene catalysts. Ethylene-based polymers are commercially available. For example, polyethylene is commercially available under the trade name ExxonMobil™ Polyethylene (available from ExxonMobil of Houston, Tex.). Ethylene-based copolymers are commercially available under the trade name ExxonMobil™ Polyethylene (available from ExxonMobil of Houston, Tex.), which include metallocene produced linear low density polyethylene including Exceed™, Enable™, and Exceed™ XP. Examples of ethylene-based thermoplastic polymers useful for certain embodiments of the present TPV compositions described herein include ExxonMobil HD7800P, ExxonMobil HD6706.17, ExxonMobil HD7960.13, ExxonMobil HD9830, ExxonMobil AD60-007, Exceed XP 8318ML, Exceed™ XP 6056ML, Exceed 1018HA, Enable™ 2010 Series, Enable™ 2305 Series, and ExxonMobil™ LLDPE LL (e.g. 1001, 1002YB, 3003 Series), all available from ExxonMobil of Houston, Tex. Additional examples of ethylene-based thermoplastic polymers useful for certain embodiments of the present TPV compositions described herein include Innate' ST50 and Dowlex™, available from The Dow Chemical Company of Midland, Mich.

In some embodiments, the PE may be any crystalline PE, preferably a high density PE (“HDPE”) which has a density (sp. gr.) of about 0.940 to about 0.965 g/cc and a MI in the range from 0.1 to 20. HDPE is commercially available in different forms, each relatively high polydispersity index (Mw/Mn) in the range from about 20 to about 40. In some embodiments, the PE is a bimodal high density PE such as ExxonMobil HD 7800P is a high-density polyethylene having a melt flow index of 0.25 g/10 min. ExxonMobil HD 7800P is available from ExxonMobil of Houston, Tex.

In one or more embodiments, the thermoplastic phase includes a polyethylene resin. In one or more embodiments, this polyethylene resin is a polyethylene homopolymer. In one or more embodiments, the polyethylene may be characterized by having a weight average molecular weight of from about 100 to 250 kg/mole, or from about 110 to 220 kg/mole, or from about 150 to 200 kg/mole. This polyethylene may be characterized by having a polydispersity index (Mw/Mn) that is less than 12, or less than 11, or less than 10, or less than 9.

The PE may be present in the thermoplastic vulcanizate composition as a blend with PP, such as isotatic polypropylene, in an amount of greater than 5 wt %, or greater than 7 wt %, or greater than 10 wt % based on the weight of the thermoplastic vulcanizate composition. The PE may be present in the thermoplastic vulcanizate composition in an amount from 5 to 25 wt % if present as a blend component with PP, such as isotactic polypropylene.

### Soft Thermoplastic Elastomer

In some preferred embodiments, the thermoplastic phase can comprise a blend of thermoplastic polyolefins described above and a soft thermoplastic elastomer in a blend ratio 5 to 80 wt % thermoplastic polyolefin and 95 to 20 wt % soft thermoplastic elastomer. In some embodiments, the soft thermoplastic elastomer has a shore A hardness ranging from 20 to 96 and when measured on the shore D scale from 20 to 50, a tensile strength at break of 2 to 20 MPa. The present disclosure further shows thermoplastic vulcanizate compositions wherein the soft thermoplastic elastomer is preferably an olefin based block copolymer comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C. The present disclosure further shows thermoplastic vulcanizate compositions wherein the soft thermoplastic elastomer is preferably an olefin based block copolymer blend comprising, an ethylene-propylene (EP) copolymer, isotactic polypropylene (iPP), and an EP-iPP diblock polymer. The present disclosure further shows thermoplastic vulcanizate compositions preferably comprise a styrene-isobutylene styrene (SIBS) in addition to or in replacement of the polypropylene homopolymer. A styrene-isobutylene styrene polymer can also be used in place of the polybutene oil. The present disclosure further shows thermoplastic vulcanizate compositions comprising a propylene-based elastomer as the thermoplastic elastomer or used in place of the polybutene oil containing units derived from major fraction of propylene and from about 5 to about 25 wt % of one or more comonomers selected from ethylene and/or C4-C12 α-olefins. The present disclosure further shows thermoplastic vulcanizate compositions comprising an olefin-based polymer constituted of 50 to 100% by weight of structural units derived from 4-methyl-1-pentene and 0 to 50% by weight of structural units derived from at least one olefin selected from olefins having 2 to 20 carbon atoms, except 4-methyl-1-pentene.

The below embodiments describe the different soft thermoplastic elastomers that are useful in this invention disclosure.

### 1. Ethylene/α-Olefin Multi-Block Copolymer

The term “ethylene/α-olefin multi-block copolymer” is a copolymer that comprises blocks or segments derived from ethylene and one or more copolymerizable α-olefin comonomers in polymerized form. The block copolymers are characterized by multiple blocks or segments of two or more polymerized monomer units resulting in blocks differ on the basis of chemical composition or physical properties. The term “ethylene/α-olefin multi-block copolymer” includes block copolymer with two blocks (di-block) and more than two blocks (multi-block). Preferably, the ethylene/α-olefin multi-block copolymer comprises crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C. Preferably, ethylene/α-olefin multi-block copolymer comprises a majority mol fraction of ethylene units, i.e., ethylene comprises at least, greater than 50 mole percent of the polymer.

More preferably ethylene comprises at least 60 mole percent, at least 70 mole percent, or at least 80 mole percent, with the remainder of the polymer comprising at least one other comonomer that is preferably an α-olefin having 3 or more carbon atoms, or 4 or more carbon atoms. For many ethylene/octene multi-block copolymers, the composition comprises an ethylene content greater than 80 mole percent of the whole polymer and an octene content of from 10 to 15, or from 15 to 20 mole percent of the whole polymer.

Suitable monomers for use in preparing the present ethylene/α-olefin multi-block copolymer include ethylene and one or more addition polymerizable monomers other than ethylene. Examples of suitable comonomers include straight-chain or branched α-olefins of 3 to 30, or 3 to 20, or 4 to 12 carbon atoms, such as propylene, 1-butene, 1-pentene, 3-methyl-1-butene, 1-hexene, 4-methyl-1-pentene, 3-methyl-1-pentene, 1-octene, 1-decene, 1-dodecene, 1-tetradecene, 1-hexadecene, 1-octadecene and 1-eicosene; cyclo-olefins of 3 to 30, or 3 to 20, carbon atoms, such as cyclopentene, cycloheptene, norbornene, 5-methyl-2-norbornene, tetracyclododecene, and 2-methyl-1,4, 5,8-dimethano-1,2,3 ,4,4a,5, 8, 8a-octahydronaphthalene; di- and polyolefins, such as butadiene, isoprene, 4-methyl-1,3-pentadiene, 1,3-pentadiene, 1,4-pentadiene, 1,5-hexadiene, 1,4-hexadiene, 1,3-hexadiene, 1,3-octadiene, 1,4-octadiene, 1,5-octadiene, 1,6-octadiene, 1,7-octadiene, ethylidenenorbornene, vinyl norbornene, dicyclopentadiene, 7-methyl-1,6-octadiene, 4-ethylidene-8-methyl-1,7-nonadiene, and 5,9-dimethyl-1,4,8-decatriene; and 3-phenylpropene, 4-phenylpropene, 1,2-difluoroethylene, tetrafluoroethylene, and 3,3,3-trifluoro-1-propene. In an embodiment, the comonomer is selected from butene, hexene, and octene. In a preferred embodiment, the comonomer is 1-octene.

The ethylene/α-olefin multi-block copolymer includes various amounts of “hard” segments and “soft” segments. “Hard” segments are blocks of polymerized units comprising a majority fraction of ethylene, such as greater than 90 weight percent. In some preferred embodiments, the hard segments include all, or substantially all, units derived from ethylene. “Soft” segments are blocks of polymerized units in which the comonomer content (content of monomers other than ethylene) is greater than that present in the hard segment. The ethylene/α-olefin multi-block copolymer can be produced via a chain shuttling process such as described in U.S. Pat. No. 7,858,706, which is herein incorporated by reference. The process is also described, for example, in the following: U.S. Pat. Nos. 7,608,668; 7,893,166; and 7,947,793.

In an embodiment, the ethylene/α-olefin multi-block copolymer is an ethylene/octene multi-block copolymer and has one, some, any combination of, or all the properties below:

(i) a melt temperature (Tm) from 100° C. to 130° C., or 105° C. to 127° C., or 115° C. to 125° C., or 118° C. to 122° C., or 125° C.;

(ii) a density from 0.86 g/cc, or 0.87 g/cc, or 0.88 g/cc to 0.89 g/cc;

(iii) a melt index (MI) from 0.2 g/10 min to 40 g/10 min, or 0.5 g/10 min to 35 g/10 min, or 0.7 g/10 min to 30 g/min, or 1 g/10 min to 10 g/10 min;

(vii) a Shore A hardness of 30 to 95, or 40 to 90, or 50 to 80, or 55 to 78, or 60 to 77;

(viii) an ultimate tensile strength of 1 to 25 MPa, 2 to 20 MPa, 1.5 to 18MPa, 3 to 17 MPa, 5 to 16 MPa, 6 to 15 MPa.

(ix) compression set at 70° C. of 20% to 120%, 30 to 100%, 40% to 80%, 45% to

In an embodiment, the ethylene/α-olefin multi-block copolymer is an ethylene/octene multi-block copolymer. In an embodiment, the ethylene/octene multi-block copolymer is sold under the Tradename INFUSE™ and available from The Dow Chemical Company, Midland, Mich., USA. In a further embodiment, the ethylene/octene multi-block copolymer is INFUSE™ 9100. In an embodiment, the ethylene/octene multi-block copolymer is INFUSE™ 9500. In an embodiment, the ethylene/octene multi-block copolymer is INFUSE™ 9507.

### 2. Propylene-Based Block Copolymer Blends

The term “Propylene-based block copolymer blends” refer to polymer compositions comprising a blend of a) soft thermoplastic polyolefin copolymer, b) a hard thermoplastic polyolefin, and c) a block copolymer having a soft segment and a hard segment comprising the same units as a) and b). The hard segment of the block copolymer is the same composition as the hard thermoplastic polyolefin in the propylene-based block copolymer blend and the soft segment of the block copolymer is the same composition as the soft thermoplastic polyolefin copolymer of the propylene-based block copolymer blend. The propylene-based block copolymer blends contain a hard segment and hard polymer comprising only or substantially only propylene monomer residues with a soft segment and soft polymer comprising only or substantially only ethylene and propylene comonomer residues. In describing propylene-based block copolymer blends, “hard” segments refer to highly crystalline blocks of polymerized units in which the comonomer content in the hard segments is less than 5 mol %, or less than 2 mol %. In some embodiments, the hard segments comprise all or substantially all propylene units. “Soft” segments, on the other hand, refer to amorphous, substantially amorphous or elastomeric blocks of polymerized units having a comonomer content greater than 10 mol %. In some embodiments, the soft segments comprise ethylene/propylene interpolymers. Further, the EP-iPP diblock polymers of the propylene-based block copolymer blends comprise from 10 to 90 wt % hard segments and 90 to 10 wt % soft segments. Within the soft segments, the weight percent ethylene may range from 10% to 75%, or from 30% to 70%. In an embodiment, propylene constitutes the remainder of the soft segment. Within the hard segments, the weight percent propylene may range from 80% to 100%. The hard segments can comprise greater than 90 wt %, 95 wt %, or 98 wt % propylene. In an embodiment the propylene-based block copolymer blends comprises an overall ethylene content from 15 to 75 wt %, or from 20 to 70 wt %, or from 25 to 65 wt %, based on the overall weight of the blend. In an embodiment, the EP-iPP diblock polymer in the propylene-based block copolymer blends has a propylene content from 57 to 52 wt %, or from 56.5 to 53 wt %, or from 56 to 53 wt %, based on the weight of the EP-iPP diblock polymer.

The propylene-based block copolymer blends employed herein can be prepared by a process comprising contacting an addition polymerizable monomer or mixture of monomers under addition polymerization conditions with a composition comprising at least one addition polymerization catalyst, a cocatalyst and a chain shuttling agent (“CSA”), the process being characterized by formation of at least some of the growing polymer chains under differentiated process conditions in two or more reactors operating under steady state polymerization conditions or in two or more zones of a reactor operating under plug flow polymerization conditions. The propylene-based block copolymer blends described herein may be differentiated from conventional, random copolymers, physical blends of polymers, and block copolymers prepared via sequential monomer addition. The propylene-based block copolymer blends may be differentiated from random copolymers by characteristics such as higher melting temperatures for a comparable amount of comonomer, as described below; from a physical blend by characteristics such as better tensile strength, improved fracture strength, finer morphology, improved optics, and greater impact strength at lower temperature; from block copolymers prepared by sequential monomer addition by molecular weight distribution, rheology, shear thinning, rheology ratio, and in that there is block polydispersity.

The propylene-based block copolymer blends can have more than melting point as determined via differential scanning calorimetry. In some embodiments, propylene-based block copolymer blends can have a highest temperature crystalline melting point (Tm) greater than 100° C., preferably greater than 120° C., and more preferably greater than 125° C. The melt index of the propylene-based block copolymer blends can range from 0.1 to 1000 g/10 min., from 0.1 to 50 g/10 min., from 0.1 to 30 g/10 min., or from 1 to 20 g/10 min.

In some embodiments, the propylene-based block copolymer blends show a shore

A hardness from 30 to 98, or 40 to 95, or 50 to 95, or 60 to 95. In some preferred embodiments, the propylene-based block copolymer blends show a shore D hardness from 5 to 60, or 10 to 55, or 15 to 50, or 15 to 45. In some embodiments, the propylene-based block copolymer blends shows a vicat softening point of 20 to 150° C., or 30 to 140° C., or 40 to 135° C., or 50 to 130° C. Preferably, the propylene-based block copolymer blends shows a tensile strength at break of 1.5 to 20 MPa, or 2 to 18 MPa, or 2 to 17 MPa, or 2.5 to 16 MPa. Preferably, the propylene-based block copolymer blends shows a compression set at 70° C. of 40 to 120%, or 50 to 100% MPa, or 55 to 90%, or 60 to 80%. Preferably, the propylene-based block copolymer blends show an ethylene content of 90 to 15 wt %, or 85 to 20 wt %, 80 to 25 wt %, 77 to 30 wt %.

Processes useful in producing the propylene-based block copolymer blends suitable for use in the present invention may be found, for example, in U.S. Patent Application Publication No. 2008/0269412, published on Oct. 30, 2008. Suitable catalysts, catalyst precursors, and co-catalysts for use in the present invention include metal complexes such as disclosed in WO 2005/090426; U.S. 2006/0199930; U.S. 2007/0167578; U.S. 2008/0311 812; U.S. 2011/0082258; U.S. Pat. No. 7,355,089; and WO 2009/012215. The propylene-based block copolymer blends themselves are more fully described in U.S. Pat. No. 8,476,366. In an embodiment, the propylene-based block copolymer blends is sold under the Tradename INTUNE™ and available from The Dow Chemical Company, Midland, Mich., USA. In a further embodiment, the propylene-based block copolymer blends are INTUNE™ D5545, INTUNE™ D5535, and INTUNE™ D10510. In a preferred embodiment, the propylene-based block copolymer blends is INTUNE™ D5545. In an embodiment, the propylene-based block copolymer blends is INTUNE™ D5535.

### 3. Polyisobutylene Block Elastomer

In some embodiments, the soft thermoplastic elastomer is a block copolymer of polyisobutylene. They are composed of rigid thermoplastic sequences connected via flexible elastomer sequences of polyisobutylene. They are often triblock elastomers with two rigid segments connected via a flexible segment of isobutylene. The rigid and flexible segments can be positioned linearly, in star fashion or in branched fashion. Preferably, the polyisobutylene block of the polyisobutylene block elastomer or block copolymer additionally has a glass transition temperature (“Tg”) of less than or equal to −20° C., more preferably of less than −40° C. The Tg of the polyisobutylene block of the block copolymer is more preferably still less than −50° C.

The thermoplastic block or blocks of the polyisobutylene block elastomer (hereinafter denoted by “hard segment”) are thus composed of at least one polymerized monomer based on unsubstituted or substituted styrene; mention may be made, among substituted styrenes, for example, of methylstyrenes (for example, o-methylstyrene, m-methyl styrene or p-methylstyrene, a-methylstyrene, a,2-dimethyl styrene, a,4-dimethyl styrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or para-hydroxystyrene.

In some preferred embodiment, the polyisobutylene block elastomer is a polystyrene and polyisobutylene block copolymer. Preferably, such a block copolymer is a styrene/isobutylene diblock copolymer. In a more preferred embodiment, such a block copolymer is a styrene/isobutylene/styrene triblock copolymer (abbreviated to “SIBS”). Below the minimum indicated thermoplastic content, the thermoplastic nature of the elastomer risks being substantially reduced, whereas, above the recommended maximum, the elasticity is impacted. For these reasons, the styrene content is more preferably between 10% and 40%, in particular between 15% and 35%. Preferably, the glass transition temperatures of the hard segment formed from styrenic polymerized monomers are greater than or equal to 100° C.

In some embodiments, the SIBS elastomer has a shore A hardness of 10 to 90, or 15 to 70, or 15 to 60, or 20 to 60, or 25 to 50. The SIBS elastomer has a tensile strength at break of, 4 to 15 MPa, or 4 to 20 MPa, or 5 to 20 MPa, or 6 to 19 MPa, or 10 to 20 MPa. In some embodiments, the SIBS elastomer has a melt flow rate (230° C., 2.16 kg) of 0.05 to 30, or 0.07 to 25, or 0.09 to 20, or 0.1 to 10, or 0.1 to 5, or 0.1 to 2. In some embodiment, SIBS elastomer has a compression set at 70° C. of 20 to 100, or 30 to 95, or 40 to 80, or 50 to 70. In some preferred embodiments, the elastomers are available commercially available, as SIB and SIBS, by Kaneka under the name “Sibstar” (e.g. “Sibstar 103T”, “Sibstar 102T”, “Sibstar 073T” or “Sibstar 072T” for the SIBSs or “Sibstar 042D” for the SIBs). They have, for example, been described, along with their synthesis, in the patent documents EP 731 112, U.S. Pat. No. 4,946,899 and U.S. Pat. No. 5,260,383. They were developed first of all for biomedical applications and then described in various applications specific to TPSI elastomers, as varied as medical equipment, motor vehicle or domestic electrical appliance parts, sheathings for electric wires, or airtight or elastic parts (see, for example, EP 1 431 343, EP 1 561 783, EP 1 566 405 and WO 2005/103146).

### 4. Propylene-Based Elastomers

The propylene-based polymers, such as propylene-based elastomers (“PBEs”). The PBE comprises propylene and from about 5 to about 30 wt % of one or more comonomers selected from ethylene and/or C4-C12 α-olefins. For example, the comonomer units may be derived from ethylene, butene, to pentene, hexene, 4-methyl-1-pentene, octene, or decene. In preferred embodiments, the comonomer is ethylene. In some embodiments, the PBE consists essentially of propylene and ethylene, or consists only of propylene and ethylene. Some of the embodiments described below are discussed with reference to ethylene as the comonomer, but the embodiments are equally applicable to PBEs with other α-olefin comonomers. In this regard, the copolymers may simply be referred to as PBEs with reference to ethylene as the α-olefin.

The PBE may include at least about 5 wt %, at least about 6 wt %, at least about 7 wt %, at least about 8 wt %, at least about 9 wt %, or at least about 10 wt %, α-olefin-derived units, based upon the total weight of the PBE. The PBE may include up to about 30 wt %, or up to about 25 wt %, up to about 22 wt %, up to about 20 wt %, up to about 17 wt %, up to about 15 wt %, up to about 13 wt %, or up to about 12 wt %, α-olefin-derived units, based upon the total weight of the PBE. In some embodiments, the PBE may comprise from about 5 to about 25 wt %, from about 6 to about 22 wt %, from about 7 wt % to about 20 wt %, from about 8 to about 17 wt %, from about 9 wt % to about 15 wt %, from about 9 wt % to about 13 wt %, or from about 10 to about 12 wt %, cc-olefin-derived units, based upon the total weight of the PBE.

The PBE may include at least about 70 wt %, or at least about 75 wt %, at least about 78 wt %, at least about 80 wt %, at least about 83 wt %, at least about 85 wt %, at least 87 wt %, or at least 88 wt %, propylene-derived units, based upon the total weight of the PBE. The PBE may include up to about 95 wt %, up to about 94 wt %, up to about 93 wt %, up to about 92 wt %, up to about 91 wt %, or up to about 90 wt %, propylene-derived units, based upon the total weight of the PBE.

The Tm of the PBE (as determined by DSC) may be less than about 110° C., less than about 100° C., less than about 90° C., less than about 80° C., less than about 70° C., less than about 65° C., less than about 60° C. The PBE may have a Tm of from about 20 to about 90° C., from about 30 to about 80° C., from about 40 to about 70° C., or from about 50 to about 65° C., where desirable ranges may include ranges from any lower limit to any upper limit. In some embodiments, the PBE may have a Tm of from about 55 to about 70° C., or from about 57 to about 68° C., or from about 60 to about 65° C., where desirable ranges may include ranges from any lower limit to any upper limit. In some embodiments, the PBE may have a Tm of from about 45 to about 65° C., or from about 50 to about 60° C., or from about 52 to about 58°

C., where desirable ranges may include ranges from any lower limit to any upper limit.

The PBE can be characterized by its heat of fusion (HD, as determined by DSC. The PBE may have an Hf that is at least about 1.0 J/g, at least about 3.0 J/g, at least about 5.0

J/g, at least about 7.0 J/g, at least about 10.0 J/g, at least about 12 J/g, at least about 15 J/g, at least about 20 J/g, or at least about 25 J/g. The PBE may be characterized by an Hf of less than about 60 J/g, less than about 50 J/g, less than about 40 J/g, less than about 35 J/g, less than about 30 J/g, less than about 25 J/g, less than about 20 J/g, less than about 15 J/g. The PBE may have a Hf of from about 1.0 to about 50 J/g, or from about 3.0 to about 40 J/g, or from about 5.0 to about 35 J/g, or from about 10.0 to about 30 J/g, where desirable ranges may include ranges from any lower limit to any upper limit. In some embodiments, the PBE may have a Hf of from about 1.0 to about 25 J/g, from about 5.0 to about 20 J/g, from about 10 to 20 J/g, or from about 12 to about 18 J/g, where desirable ranges may include ranges from any lower limit to any upper limit. In some embodiments, the PBE may have a Hf of from 5.0 to about 40 J/g, from about 10.0 to about 35 J/g, from about 15 to about 35 J/g, or from about 20 to about 30 J/g, or from about 25 to about 30 J/g, where desirable ranges may include ranges from any lower limit to any upper limit.

The PBE has a density of from about 0.84 g/cm3 to about 0.92 g/cm3, from about 0.85 g/cm3 to about 0.90 g/cm3, or from about 0.86 g/cm3 to about 0.88 g/cm3 at room temperature, as measured per the ASTM D-1505 test method, where desirable ranges may include ranges from any lower limit to any upper limit.

The PBE can have a melt index (MI) (ASTM D-1238, 2.16 kg @ 190° C.), of less than or equal to about 25 g/10 min, less than or equal to about 10 g/10 min, less than or equal to about 8.0 g/10 min, less than or equal to about 5.0 g/10 min, or less than or equal to about 2.0 g/10 min. In some embodiments, the PBE has a MI of from about 0.5 to about 3.0 g/10 min or form about 0.75 to about 2.0 g/10 min, where desirable ranges may include ranges from any lower limit to any upper limit. In some embodiments, the PBE has a MI of from about 1.0 to about 25 g/10 min, or from about 1.0 to about 10 g/10 min, or from about 2.0 to about 6.0 g/10 min, or from about 2.5 to about 5.0 g/10 min, or from about 2.5 to about 25 g/10 min, or from about 2.5 to about 10 g/10 min, where desirable ranges may include ranges to from any lower limit to any upper limit.

The PBE may have a melt flow rate (MFR), as measured according to ASTM D-1238 (2.16 kg weight @ 230° C.), greater than about 0.5 g/10 min, greater than about 1.0 g/10 min, greater than about 1.5 g/10 min, greater than about 2.0 g/10 min, or greater than about 2.5 g/10 min. The PBE may have an MFR less than about 25 g/10 min, less than about 15 g/10 min, less than about 10 g/10 min, less than about 7 g/10 min, or less than about 5 g/10 min. The PBE may have an MFR from about 0.5 to about 15 g/10 min, from about 1.0 to about 10 g/10 min, or from about 1.5 to about 9 g/10 min, where desirable ranges may include ranges from any lower limit to any upper limit. In some embodiments, the PBE may have a MFR of from about 2.5 to about 25 g/10 min, or from about 2.5 to about 15 g/10 min, or from about 2.5 to about 12 g/10 min, or form about 5.0 to about 10 g/10 min, where desirable ranges may include ranges from any lower limit to any upper limit. In some embodiments, the PBE may have a MFR of from about 0.5 to about 7.0 g/10 min, or from about 1.0 to about 6.0 g/10 min, or from about 2.0 to about 5.0 g/10 min, where desirable ranges may include ranges from any lower limit to any upper limit.

The PBE may have a Shore D hardness of less than about less than about 50, or less than about 45, or less than about 40, or less than about 35. The PBE may have a Shore D hardness of from about 10 to about 50, or from about 15 to about 45, or from about 20 to about 40, or from about 25 to about 35, where desirable ranges may include ranges from any lower limit to any upper limit. The PBE may have a shore A hardness greater than 10, or greater than 20, or greater than 40, or greater than 50; such as between 40 to 90.

The PBE may have a Vicat softening temperature of less than 100° C., or less than 90° C., or less than 80° C., or less than 75° C., or less than 70° C. The PBE may have a Vicat softening temperature of at least 30° C., or at least 40° C., or at least 50° C. or at least 60° C.

The PBE are preferably prepared using homogeneous conditions, such as a continuous solution polymerization process. Exemplary methods for the preparation of propylene-based polymer may be found in U.S. Pat. Nos. 6,881,800; 7,803,876; 8,013,069; and 8,026,323 and PCT Publications WO 2011/087729; WO 2011/087730; and WO 2011/087731. In some embodiments, the thermoplastic component of the TPV composition may include impact and/or random copolymers of propylene with ethylene or the higher α-olefins, described above, or with C₁₀ to C₂₀ diolefins. Comonomer contents for these propylene copolymers may be from about 1% to about 30% by weight of the polymer, encompassing any value and subset therebetween, for example, as in U.S. Pat. No. 6,867,260, which is incorporated by reference herein in its entirety. Suitable commercially available thermoplastic components include olefinic elastomers under the tradename VISTAMAXX™ (available from ExxonMobil Chemical Company, Houston, Tex. or VERSIFY™ available from the Dow Chemical Company, Midland, Mich.).

5. 4-methyl-1-pentene/α-olefin copolymer

The 4-methyl-1-pentene/α-olefin copolymers according to the present invention comprises:

5 to 95 mol % of a structural unit derived from (i) 4-methyl-1-pentene,

95 to 5 mol % of a structural unit (ii) derived from at least one kind of α-olefin selected from α-olefins having 2 to 20 carbon atoms excluding 4-methyl-1-pentene, and

0 to 10 mol % of a structural unit (iii) derived from a non-conjugated polyene, provided that the total of the structural units (i), (ii), and (iii) is 100 mol %.

This copolymer comprises the structural unit of 4-methyl-1-pentene, preferably in an amount of 10 to 90 mol %, more preferably 15 to 85 mol %, still more preferably 15 to 80 mol %, most preferably 15 to 75 mol %; and the structural unit (ii) preferably in an amount of 90 to 10 mol %, more preferably 85 to 15 mol %, still more preferably 85 to 20 mol %, most preferably 85 to 25 mol %, provided that the total of the structural units (i) and (ii) is 100 mol %. In the present invention, “an α-olefin having 2 to 20 carbon atoms” does not include 4-methyl-1-pentene, unless otherwise noted. Meanwhile, any other copolymerization component may be contained therein, to the degree not adversely affecting the object of the present invention; and the embodiments thereof are within a scope of the present invention.

In addition, the copolymer satisfies at least the following requirements:

The copolymer has a tensile modulus (YM) of 0.1 to 1000 MPa, preferably 0.1 to 500 MPa, more preferably 0.1 to 300 MPa, still more preferably 0.1 to 200 MPa. When the tensile modulus is within the above range, for example, mechanical properties, toughness, flexibility, and stress absorption are excellent.

The copolymer has a melting point (Tm), as measured by DSC, of preferably lower than 110° C. or not observed, more preferably lower than 100° C. or not observed, still more preferably lower than 85° C. or not observed. The melting point of the copolymer (A) can be varied arbitrarily by types and compositions of the comonomers. When the melting point is within the above range, flexibility and toughness are excellent.

The copolymer has a density, as measured in accordance with ASTM D 1505 (water replacement method), preferably in the range of 0.810 to 0.850 g/cm3, more preferably 0.820 to 0.850 g/cm3, more preferably 0.830 to 0.850 g/cm3.

It is preferable that the copolymer satisfies the following requirements (c1) and (e).

(c1): The tensile modulus (YM) is 0.1 to 300 MPa, preferably 0.1 to 250 MPa, more preferably 0.3 to 200 MPa. When the tensile modulus is within the above range, mechanical properties, toughness, flexibility, and stress absorption are excellent.

(e): The change AHS in Shore A hardness between immediately after the measurement and 15 seconds after the measurement is 10 to 50, preferably 15 to 50, more preferably 20 to 50. The change in Shore A hardness is obtained as follows in accordance with JIS K 6253.

AHS=(Shore A hardness 15 seconds after the measurement—Shore A hardness immediately after the measurement)

The AHS value can be varied arbitrarily by types and compositions of comonomers.

When AHS is within the above range, stress absorption and stress relaxation are excellent.

A 4-methyl-1-pentene/α-olefin copolymer (A2) comprises:

33 to 80 mol %, preferably 50 to 75 mol % of the structural unit (i),

67 to 20 mol %, preferably 50 to 25 mol % of the structural unit (ii), and

0 to 10 mol %, preferably 0 to 5 mol % of the structural unit (iii), provided that the total of the structural units (i), (ii), and (iii) is 100 mol %; and

satisfies any one or more of Shore A hardness and Shore D hardness in the following requirement (el), in addition to at least the requirements (a) to (d).

The 4-methyl-1-pentene/α-olefin copolymer (A2) is preferable because of having excellent stress relaxation.

(e1): The difference AHS in Shore A hardness between immediately after the starting of indenter contact and 15 seconds after the starting of indenter contact is 15 to 50, preferably 20 to 50, more preferably 23 to 50; or the difference AHS in Shore D hardness between immediately after the starting of indenter contact and 15 seconds after the starting of indenter contact is 5 to 50, preferably 8 to 50, more preferably 10 to 50.

The linear α-olefins are those having 2 to 20 carbon atoms, preferably 2 to 15 carbon atoms, more preferably 2 to 10 carbon atoms, with examples thereof including ethylene, propylene, 1-butene, 1-pentene, 1-hexene, 1-octene, 1-decene, 1-undecene, 1-dodecene, 1-tetradecene, 1-hexadecene, 1-octadecene, and 1-eicosene; and ethylene, propylene, 1-butene, 1-pentene, 1-hexene, and 1-octene are preferable. In the present invention, in terms of flexibility, stress absorption, stress relaxation and the like, the linear α-olefins having 2 to 10 carbon atoms are preferable; and ethylene, propylene, 1-butene, 1-pentene, 1-hexene, and 1-octene are more preferable. In terms of providing high stress absorption and polyolefin modification property, ethylene and propylene are still more preferable; and propylene is particularly preferable. Suitable commercially available 4-methyl-1-pentene/propylene copolymer components include those under the tradename Absortomer (available from Mitsui Chemical).

In some embodiments, the 4-methyl-1-pentene/propylene copolymer is a Absortomer EP-1001; in some embodiments, the 4-methyl-1-pentene/propylene copolymer is a Absortomer EP-1013.

Processing Oils and other Additives

### Hydrocarbon Resin

The present thermoplastic vulcanizate compositions may further include a “hydrocarbon resin” (HCR) with a high glass transition temperature (Tg), or a high softening point, or both. It is contemplated that the hydrocarbon resin can be any of a number of different types of polymers, as specified below, provided it has the requisite properties.

The hydrocarbon resin may be a thermally polymerized dicyclopentadiene resin which is preferably hydrogenated to achieve transparency and minimize discoloration. The hydrocarbon resin may also be a catalytically polymerized resin made using a Friedel-Crafts catalyst such as boron or aluminum halides. The hydrocarbon resin may be a cycloaliphatic resin or contain appropriate levels of aromatics.

A particularly preferred hydrocarbon resin is OPPERA PR104, supplied by ExxonMobil Chemical Co, which has a Tg of 65° C. and a softening point ranging from 119 to 125° C. Preferably, as noted below, the hydrocarbon resin is miscible with both, or at least one, of the polymer components (FPC and SPC). Also, the hydrocarbon resin itself should be clear, preferably colorless, or transparent; preferably, a water white cycloaliphatic hydrocarbon resin.

In at least certain embodiments, the hydrocarbon resin has a high glass transition temperature Tg, that is higher by at least 1° C. than the Tg of the composition (including process oil if present) when the hydrocarbon resin is absent. Alternatively, in certain embodiments, the Tg of the hydrocarbon resin is higher than the Tg of each of the other individual polymers.

In certain embodiments, the glass transition temperature Tg of the hydrocarbon resin is one within the range having a low of 20° C., or 30° C., or 40° C., and a high of 70° C., or 80° C., or 90° C. The hydrocarbon resin preferably has a glass transition temperature, by DSC, of greater than 20° C.

In certain embodiments, the hydrocarbon resin has a softening point within the range having a lower limit of 80° C., 120° C., or 125° C. and an upper limit of 140° C., 150° C., or 180° C. Softening point (° C.) is measured as a ring and ball softening point according to ASTM E-28.

Preferably, the hydrocarbon resin is amorphous and glassy, with low molecular weight. Preferably, the hydrocarbon resin has a lower molecular weight than either of the blend polymers. In certain embodiments, the hydrocarbon resin may have a number average molecular weight (Mn) within the range having an upper limit of 5000, or 2000, or 1000, and a lower limit of 200, or 400, or 500, a weight average molecular weight (Mw) ranging from 500 to 5000, a Z average molecular weight (Mz) ranging from 500 to 10,000, and a polydispersity (PD) as measured by Mw/Mn of from 1.5 to 3.5, where Mn, Mw, and Mz are determined by size exclusion chromatography (SEC).

The hydrocarbon resin should be present in the compositions in an amount ranging from a lower limit of 1%, 5%, or 10% by weight based on the total weight of the composition, to an upper limit of 30%, or 25%, or 20%, or 18%, or 15% by weight based on the total weight of the composition.

A hydrocarbon resin can include any of the following compounds, to the extent they are otherwise appropriate, e.g., having the requisite properties described elsewhere herein. Additionally, they should provide (or at least not reduce) transparency: Examples of hydrocarbon resins include aliphatic hydrocarbon resins, hydrogenated aliphatic hydrocarbon resins, aromatic modified aliphatic hydrocarbon resins, hydrogenated aromatic modified aliphatic hydrocarbon resins, polycyclopentadiene resins, hydrogenated polycyclopentadiene resins, cycloaliphatic hydrocarbon resins, hydrogenated cycloaliphatic resins, cycloaliphatic/aromatic hydrocarbon resins, hydrogenated cycloaliphatic/aromatic hydrocarbon resins, hydrogenated aromatic hydrocarbon resins, maleic acid/anhydride modified tackifiers, polyterpene resins, hydrogenated polyterpene resins, aromatic modified polyterpene resins, hydrogenated aromatic modified polyterpene resins, terpene-phenol resins, hydrogenated terpene-phenol resins, gum rosin resins, hydrogenated gum rosin resin, gum rosin ester resins, hydrogenated gum rosin ester resins, wood rosin resin, hydrogenated wood rosin resins, wood rosin ester resins, hydrogenated wood rosin ester resins, tall oil rosin resins, hydrogenated tall oil rosin resins, tall oil rosin ester resins, hydrogenated tall oil rosin ester resins, rosin acid resins, hydrogenated rosin acid resins, and mixtures of two or more thereof. These materials are preferably low molecular weight materials having a molecular weight (Mw) below 10,000, more preferably below 5,000, more preferably below 2500, more preferably below 2000, with suitable ranges falling in between 1 and 1000, more preferably 500-2000, more preferably 500-1000.

Specific examples of commercially available hydrocarbon resins include Oppera PR 100, 101, 102, 103, 104, 105, 106, 111, 112, 115, and 120 materials, and Oppera PR 131 hydrocarbon resins, all available from ExxonMobil Chemical Company, ARKON™ M90, M100, M115 and M135 and SUPER ESTER™ rosin esters available from Arakawa Chemical Company of Japan, SYLVARES™ phenol modified styrene- and methyl styrene resins, styrenated terpene resins, ZONATAC terpene-aromatic resins, and terpene phenolic resins available from Arizona Chemical Company, SYLVATAC™ and SYLVALITE™ rosin esters available from Arizona Chemical Company, NORSOLENE™ aliphatic aromatic resins available from Cray Valley of France, DERTOPHENE™ terpene phenolic resins available from DRT Chemical Company of Landes, France, EASTOTAC™ resins, PICCOTACT™ C5/C9 resins, REGALITE™ and REGALREZ™ aromatic and REGALITE™ cycloaliphatic/aromatic resins available from Eastman Chemical Company of Kingsport, Tenn., WINGTACK™ ET and EXTRA available from Goodyear Chemical Company, FORAL™, PENTALYN™, AND PERMALYN™ rosins and rosin esters available from Hercules (now Eastman Chemical Company), QUINTONE™ acid modified C5 resins, C5/C9 resins, and acid modified C5/C9 resins available from Nippon Zeon of Japan, and LX™ mixed aromatic/cycloaliphatic resins available from Neville Chemical Company, CLEARON hydrogenated terpene aromatic resins available from Yasuhara. The preceding examples are illustrative only and by no means limiting.

These commercial compounds generally have a Ring and Ball softening point (measured according to ASTM E-28) of about 10-200 C, more preferably about 10-160 C, more preferably about 25-140 C, more preferably about 60-130 C, more preferably about 60-130 C, more preferably about 90-130 C, more preferably about 80-120 C, more preferably about 85-115 C, and more preferably about 90-110 C, wherein any upper limit and any lower limit of softening point may be combined for a preferred softening point range. For hydrocarbon resins a convenient measure is the ring and ball softening point determined according to ASTM E-28.

### Processing Oils

In some embodiments, the processing oil comprises a low molecular weight of C4 olefins (including n-butene, 2-butene, isobutylene, and butadiene, and mixtures thereof). Such a material is referred to as a “polybutenes” liquid when the oligomers comprise isobutylene and/or 1-butene and/or 2-butene. It is commonly used as an additive for polyolefins; e.g. to introduce tack or as a processing aid. The ratio of C4 olefin isomers can vary by manufacturer and by grade, and the material may or may not be hydrogenated after synthesis. In some cases, the polybutenes liquid is a polymer of a C4 raffinate stream. In other cases, it consists essentially of polyisobutylene or poly(n-butene) oligomers. Typically, the polybutenes liquid has a number-average molecular weight of less than 15,000 g/mol, and commonly less than 5,000 g/mol or even less than 1,000 g/mol. They are described in, for example, SYNTHETIC

LUBRICANTS AND HIGH-PERFORMANCE FUNCTIONAL FLUIDS 357-392 (Leslie R. Rudnick & Ronald L. Shubkin, ed., Marcel Dekker 1999). Commercial sources of polybutenes include Ineos (Indopol grades) and Infineum (C-Series grades). When the C4 olefin is exclusively isobutylene, the material is referred to as “polyisobutylene” or PM. Commercial sources of PIB include Texas Petrochemical (TPC Enhanced PIB grades). When the C4 olefin is exclusively 1-butene, the material is referred to as “poly-n-butene” or PNB. Properties of some liquids made from C4 olefin(s) are summarized in the Table below. Note that grades with a flash point of 200° C. or more also have a pour point greater than —10° C. and/or a VI less than 120.

Commercial Examples of Oligomers of C4 olefin(s) KV @ Pour Flash 100° C.,

Point, Specific Point, Grade cSt VI ° C. gravity ° C. TPC 137 (PIB) 6 132 −51 0.843 120 TPC 1105 (PIB) 220 145 −6 0.893 200 TPC 1160 (PIB) 660 190 3 0.903 230 Ineos Indopol H-25 52 87 −23 0.869 −150 Ineos Indopol H-50 108 90 −13 0.884 —190 Ineos Indopol H-100 218 121 —7 0.893 −210 Infineum C9945 11 74* −34 0.854 170 Infineum C9907 78 103* −15 0.878 204 Infineum C9995 230 131* −7 0.888 212 Infineum C9913 630 174* 10 0.888 240 *Estimated based on the kinematic viscosity at 100° C. and 38° C.

### Curative

The compositions contains curing agents, including amine based curing agents wherein the one or more amine curing agents is selected from (6-aminohexyl)carbamic acid, N,N′-dicinnamylidene-1,6-hexamethylenediamine, 4,4′-methylenebis(cyclohexylamine)carbamate, 1,3 ,5-triallyl-1,3, 5-triazine-2,4,6(1H,3H,5H)-trione, trimethylallyl isocyanurate, N-(1,3-dimethylbutyl)-N′-phenyl-p-phenylenediamine, N,N′-Diphenyl-p-phenylenediamine, N,N-Diethyl-p-phenylenediamine. Most preferably the material is selected from the group consisting of 4,4′-methylene-bis-(cyclohexylamine)carbamate (commercially available from R.T. Vanderbilt Co., Norwalk,

Conn. under the tradename Diak®).

### Pharmaceutical Stopper Compositions

Pharmaceutical stoppers can comprise thermoplastic elastomeric compositions described herein that comprise an at least partially crosslinked thermoplastic elastomer composition that comprises: one or more BIMSM having a Mooney viscosity (ML 1+8, 125° C.) of 30 MU to 50 MU, according to the ASTM D1646 test method, and/or a benzylic bromine content of 0.3 mol % to 5 mol %; 10 to 50 phr of a PPH having a melt flow rate (MFR) (230° C./2.16 kg) of 0.2-2000 g/10 min (or 0.5-1500 g/10 min, or 0.5-1000 g/10 min, or 0.5-500 g/10 min, or 0.5-100 g/10 min, more preferably 0.5-20 g/10 min), based on the ASTM D1238 test method); one or more curing agent(s) (e.g., present at 0.1-15 phr, or 0.5-10 phr); 10 to 100 phr (before and/or after curing) of a process oil comprising a polyisobutene polymer; and optionally additional additives; and wherein the thermoplastic elastomer composition is cured using a phenolic resin-based cure system, a sulfur-based cure system, or an amine-based cure system.

Pharmaceutical stoppers can comprise thermoplastic elastomer compositions described herein that comprise an at least partially crosslinked elastomer phase that comprises:

one or more BIMSM having a Mooney viscosity (ML 1+8, 125° C.) of 30 MU to 50 MU, according to the ASTM D1646 test method, and/or a benzylic bromine content of 0.3 mol % to 5 mol %; 10 to 90 phr of a thermoplastic phase; one or more curing agent(s) (e.g., present at 0.1-15 phr, or 0.5-10 phr); 10 to 100 phr (before and/or after curing) of a process oil comprising a polyisobutene polymer; and optionally additional additives; and wherein the thermoplastic elastomer composition is cured using a phenolic resin-based cure system, a sulfur-based cure system, or an amine-based cure system.

To form the thermoplastic elastomer compositions in accordance with at least one embodiment of the present disclosure, the thermoplastic elastomer compositions may be compounded or otherwise mixed according to suitable mixing methods; and molded into pharmaceutical articles, wherein crosslinking and/or curing occurs per known methods and at known points during the method of forming the pharmaceutical stoppers and/or related thermoplastic elastomer composition

### Example Embodiments

Embodiments disclosed herein include:

A: A thermoplastic elastomer composition comprising: one or more brominated isobutylene paramethyl-styrene terpolymers; and 20 to 50, or 10 to 80 parts by weight per hundred parts by weight rubber (phr) of a thermoplastic phase; wherein the thermoplastic elastomer composition is cured using a phenolic resin-based cure system, a sulfur-based cure system, or an amine-based cure system.

B: A thermoplastic vulcanizate composition comprising: an elastomer phase comprising one or more brominated isobutylene paramethyl-styrene terpolymers; 10 to 90 parts by weight per hundred parts by weight rubber (phr) of a thermoplastic phase comprising a blend of one or more thermoplastic polyolefins and one or more soft thermoplastic elastomers, wherein the soft thermoplastic elastomer has a shore A hardness from 20 to 96, a shore D hardness from 20 to 50 and a tensile strength at break of 2 to 20 MPa; and 10 to 100 phr of a process oil; wherein the elastomer phase is cured using a phenolic resin-based cure system or an amine-based cure system.

C: A pharmaceutical stopper comprising: A thermoplastic vulcanizate composition comprising: an elastomer phase comprising one or more brominated isobutylene paramethyl-styrene terpolymers; 10 to 90 parts by weight per hundred parts by weight rubber (phr) of a thermoplastic phase comprising a blend of one or more thermoplastic polyolefins and one or more soft thermoplastic elastomers, wherein the soft thermoplastic elastomer has a shore A hardness from 20 to 96, a shore D hardness from 20 to 50 and a tensile strength at break of 2 to 20 MPa; and 10 to 100 phr of a process oil; wherein the elastomer phase is cured using a phenolic resin-based cure system or an amine-based cure system.

Each of embodiments A, B and C may have one or more of the following additional elements in any combination:

Element 1: wherein the thermoplastic phase is present at 30 to 80 phr.

Element 2: wherein the process oil is present at 40 phr to 80 phr, or 50 phr to 70 phr.

Element 3: wherein the phenolic resin-based cure system comprises curing agents including one or more of: 0.1 to 20 phr of stannous chloride; 0.1 to 15 phr of metal oxide; 0.05 to 10 phr of stearic acid; and 0.5 to 20 phr of phenolic resin.

Element 4: wherein the phenolic resin is an alkyl phenolic resin.

Element 5: wherein the sulfur cure system comprises sulfur curing agents including one or more of: 0.1 to 10 phr of MBTS; 0.01 to 5 phr of sulfur; 0.1 to 10 phr of metal oxide; and 0.5 to 15 phr of stearic acid.

Element 6: wherein the metal oxide is selected from magnesium oxide (MgO), zinc oxide (ZnO), manganese oxide (MnO), sodium oxide (Na2O), iron oxide (Fe2O3), silicon dioxide (SiO₂), calcium oxide (CaO), aluminum oxide (Al₂O₃), or a mixture thereof.

Element 7: wherein the amine cure system comprises one or more amine curing agents present at 0.1 to 10 phr.

Element 8: wherein the one or more amine curing agents is selected from (6-aminohexyl)carbamic acid, N,N′-dicinnamylidene-1,6-hexamethylenediamine, 4,4′-methylenebis(cyclohexylamine)carbamate, 1,3 ,5-triallyl-1,3,5-triazine-2,4,6(1H,3H,5H)-trione, trimethylallyl isocyanurate, N-(1,3-dimethylbutyl)-N′-phenyl-p-phenylenediamine, N,N′-Diphenyl-p-phenylenediamine, N,N-Diethyl-p-phenylenediamine.

Element 9: wherein a clay is present at 1 to 30 phr.

Element 10: wherein the composition has a specific gravity at about 23° C. of from 0.8 g/cm³ to 1 g/cm³.

Element 11: wherein the composition has a moisture vapor (%) of from 0.01% to 0.03%.

Element 12: wherein the composition has an extrusion surface Ra (μm) of from 140 to 190.

Element 13: wherein the composition has a Tensile Strength (MPa) of from 1 to 10.

Element 14: wherein the composition has a 100% Modulus (MPa) of from 1 to 5.

Element 15: wherein the composition has an elongation at break (%) of from 100 to 500.

Element 16: wherein the composition has a permeability (cc.mm/m²·day.mmHg) of from 0.1 to 1.

Element 17: wherein the composition has a punch force (maximum force (N) out of 10 punctures) of from 1 to 10.

By way of non-limiting example, exemplary combinations applicable to A, B, C include: A, B, or C with 1 and 2; A, B, or C with 1, 2, and 7; A, B, or C with 8 and 9; A, B, or C with 10, 11, and 17, and so on.

Embodiments of the present disclosure further include thermoplastic vulcanizate compositions that show improved coring performance, self-sealing, low punch force, excellent oxygen barrier properties, and improved compression set at elevated temperatures.

It is to be understood that while the invention has been described in conjunction with the specific embodiments thereof, the foregoing description is intended to illustrate and not limit the scope of the invention. Other aspects, advantages and modifications will be apparent to those skilled in the art to which the invention pertains.

To facilitate a better understanding of the embodiments of the present invention, the following examples of preferred or representative embodiments are given. In no way should the following examples be read to limit, or to define, the scope of the invention.

### EXAMPLES

Tension set was measured according to ASTM D-412. Permeability was expressed as cc·mm/m²·day mmHg, and measured according to the following method: the barrier and permeability properties of the elastomer compounds were tested using a MOCON OX-TRAN 2/61 with MOCON Permeability System Software, WINPERM™, designed to measure the rate at which oxygen passes through a test material. The elastomer compound was molded in to 0.3 mm circular film specimen of approximately 1 7/8 in. diameter, and air was used for testing. The transmission rate was used to calculate the permeability coefficient. Specific gravity was measured according to ASTM D-792 method, at 23° C. Tensile and elongation were measured according to ISO 37 method. Extrusion surface Ra (surface roughness) was measured according to ExxonMobil internal test method, using a stylus profilometer. Moisture vapor (%) was measured according to ASTM D-7191-05 method. Hardness was measured according to ASTM D-2240 method. Tensile modulus was measured according to ISO 37 method. Punch Force, Self-sealing, and Fragmentation performance was measured according to process specified in the United States Pharmacopeia (USP) 381 “Elastomeric Closure for Injections” standards. Surface roughness was tested on Model Perthometer S2 surface measuring equipment.

Table 1 illustrates the inventive thermoplastic elastomer compositions E1-E3, and the different cure systems of the thermoplastic elastomer compositions, the phenolic resin cure system (E1), the sulfur cure system (E2), and the amine cure system (E3). Stannous chloride is a curing accelerator. Stearic acid is a vulcanization activator. MBTS is 2-2′-dithiobis(benzothiazole), a sulfur vulcanization accelerator. ICECAP™ clay is a mineral rubber filler, used to deliver specific ingredients to the right location in the reactive extrusion process, such as the stannous chloride powder.

BIMSM-1: brominated copolymer of isobutylene and paramethylstyrene. Mooney viscosity (ML1+8, 125° C.) =45; Benzylic Bromine =1.20 (mol %); Calcium (wt %) =0.09. Available under the tradename Exxpro, from ExxonMobil.

BIMSM-2: brominated copolymer of isobutylene and paramethylstyrene. Mooney viscosity (ML1+8, 125° C.) =35; Benzylic Bromine =0.75 (mol %); Calcium (wt %) =0.09. Available under the tradename Exxpro, from ExxonMobil.

PP-1: homopolymer PP, with a low melt flow rate of 0.83 g/10 min (230° C./2.16 kg) that provides high melt strength and resistance to softening at elevated temperature available from ExxonMobil.

PP-2: homopolymer PP, with a melt flow rate (230° C., 2.16kg) of 17 g/10 min (as per ASTM D-1238) available from Braskem.

Amine cure-1: a chemical containing 4,4,-bis(aminocyclohexyl) methane carbamate available from Vanderbilt Chemicals.

INDOPOL™ H100 is polyisobutene (PM) polymer, used as a processing aid due to its miscibility in the BIMSM polymer and its acceptance in the pharmaceutical applications where other oils and plasticizers are not typically allowed. The terpolymer content in all the formulations (examples E1-E3) was 100 phr, and the total content of INDOPOL™ H100 in all the formulations was 64.3 phr. The polypropylene homopolymer matrix of the thermoplastic elastomer compositions allowed for melt flow and injection molding. The brominated isobutylene paramethyl-styrene terpolymer portion (i.e., the BIMSM portion) of the thermoplastic elastomer compositions provided physical properties required for the pharmaceutical stopper application (e.g., low permeability, re-sealability, low fragmentation, etc.).

The descriptions above listed different venues to adjust the formulation to fit the requirements. The adjustments are interchangeable between different cure systems. Compositions E2 and E3 were produced in Brabender mixer, whereas composition El was produced in a twin screw extruder.

TABLE 1
Blend Compositions and Conditions

| Initial Formulation | E1 | E2 | E3 |
|---|---|---|---|
| BIMSM-1 (phr) | 100.0 | 100.0 | |
| BIMSM-2 (phr) | | | 100.0 |
| ICECAP ™ clay (phr) | 5.0 | 5.0 | 5.0 |
| Stannous chloride powder (phr) | 1.3 | | |
| ICECAP ™ clay (phr) | 5.0 | 5.0 | 5.0 |
| Magnesium oxide powder (phr) | 2.0 | 0.5 | |
| Zinc oxide (phr) | 2.0 | 2.0 | |
| Stearic acid (phr) | 1.0 | 1.0 | |
| Phenolic resin SP-1045 ™ (phr) | 3.5 | | |
| MBTS (phr) | | 1.5 | |
| Sulfur (phr) | | 0.5 | |
| Amine cure-1 (phr) | | | 0.8 |
| PP-1 (phr) | | | 30.0 |
| PP-2 (phr) | 37.0 | 37.0 | |
| INDOPOL ™ H100 (before curing) (phr) | 42.3 | 42.3 | 42.3 |
| INDOPOL ™ H100 (after curing) (phr) | 22.0 | 22.0 | 22.0 |
| Total (phr) | 221.1 | 216.8 | 205.1 |

Table 2 illustrates the physical properties of example El. Table 2 includes the specific gravity, the moisture vapor, the extrusion surface, the hardness (Shore A), the tensile, the compression set, and the permeability of El. The comparative example Cl is an elastomer comprising a brominated isobutylene paramethyl-styrene terpolymer, EXXPRO™ Specialty Elastomer Grade 3433, used herein as a performance reference for a pharma thermoset rubber formulation.

TABLE 2
Physical Properties

| | E1 | C1 |
|---|---|---|
| Specific Gravity (22.7° C.) | 0.9571 | |
| Vapor Moisture (%) | 0.0245 | |
| Ceast (LCR at 1200 1/s) | 118.229 | |
| Extrusion Surface Ra (μin) | 160 | |
| Hardness (ISO) Shore A | 75 | 46 |
| Tensile M100 (MPa) | 4 | 1.5 |
| Tensile UTS (MPa) | 16 | 4.5 |
| Tensile UE (%) | 360 | 550 |
| Permeability | 0.458 | 0.3 |
| (cc · mm/m² · day · mmHg) | | |

In order to evaluate the closure performance of the thermoplastic elastomer compositions, and to determine if the USP 381 Type I-II requirements for elastomeric closures can be met or exceeded, pharmaceutical application performance tests were performed (see Table 3). Such performance tests would help identify the elastomeric closures (i.e., stoppers) that might be acceptable for use with injectable preparations on the basis of their biological reactivity, their aqueous extract physicochemical properties, and their functionality. The pharmaceutical application performance tests were performed on example El. The comparative example C2 is a set of required performance properties as described in the US Pharmacopeia guidelines (USP 381). Punch force, self-sealing, and fragmentation performance was measured according to process specified in USP 381. Acceptable performance in fragmentation of the thermoplastic elastomer composition E1 was achieved, thus meeting the USP 381 Type 1 and II requirements for elastomeric closures.

TABLE 3
Pharmaceutical Application Performance Tests

| | E1 | C2 |
|---|---|---|
| Punch Force Test | 5.1 | <10 |
| maximum force (N) out of 10 punctures | | |
| at one per vial | | |
| Self-Sealing Test | 4 | 0 |
| number of vials passed out of 10 samples | | |
| Fragmentation Test | 7 | 5 |
| number of fragmented particles out of 48 | | |
| punctures across 12 vials | | |

Table 4 illustrates the formulation of the amine-cured thermoplastic elastomer compositions E4-E6.

Amine cure-2: a chemical containing dicinnamylidene hexamethylenediamine available from Vanderbilt Chemicals.

Amine cure-3: a chemical containing (6-Aminohexyl)carbamic acid available from Vanderbilt Chemicals.

The terpolymer content in all the formulations (examples E4-E6) was 100 phr, and the total content of INDOPOL™ H100 in all the formulations was 64.3 phr. C3 is a control compound for comparison purposes. The comparative example C3 is a thermoplastic elastomer composition comprising the same amount of BIMSM-2 (100 phr) and PP-1 (30 phr) as the inventive thermoplastic elastomer compositions E4-E6. The comparative example C3 differed from the thermoplastic elastomer compositions E4-E6 by the curing system: C3 was cured using the phenolic resin-based cure system.

TABLE 4
Amine-Based Cure System: Blend Compositions and Conditions

| Formulation | C3 | E4 | E5 | E6 |
|---|---|---|---|---|
| BIMSM-2 (phr) | 100.00 | 100.00 | 100.00 | 100.00 |
| PP-1 (phr) | 30.00 | 30.00 | 30.00 | 30.00 |
| ICECAP ™ clay (phr) | 10.00 | 10.00 | 10.00 | 10.00 |
| INDOPOL ™ H100 | 42.30 | 42.30 | 42.30 | 42.30 |
| (before curing) (phr) | | | | |
| INDOPOL ™ H100 | 22.00 | 22.00 | 22.00 | 22.00 |
| (after curing) (phr) | | | | |
| Zinc oxide (phr) | 5.00 | | | |
| Phenolic resin SP-1045 ™ (phr) | 5.00 | | | |
| Amine cure-1 (phr) | | 1.75 | | |
| Amine cure-2 (phr) | | | 2.25 | |
| Amine cure-3 (phr) | | | | 1.10 |
| Total (phr) | 214.30 | 206.05 | 206.55 | 205.4 |

Table 5 illustrates the physical properties of unaged thermoplastic elastomer compositions E4-E6. Table 5 includes the hardness (Shore A), the tensile, the elongation, and the specific gravity of examples E4-E6. As demonstrated in Table 5, the required physical properties for the pharmaceutical stopper applications were achieved with the thermoplastic elastomer compositions E4-E6, with E4-E6 providing suitable melt flow and injection molding properties for pharmaceutical articles.

TABLE 5
Physical properties of the unaged thermoplastic elastomer
compositions for the amine-based cure system

| | C3 | E4 | E5 | E6 |
|---|---|---|---|---|
| Hardness, Shore A (15 | 44.9 | 53.0 | 48.0 | 48.4 |
| seconds), 22 hrs, at 70° C. | | | | |
| 100% Modulus (MPa) | 2.38 | 2.11 | 1.67 | 1.82 |
| Tensile strength (MPa) | 4.32 | 2.98 | 2.56 | 2.74 |
| Ultimate elongation, % | 372 | 161 | 207 | 177 |
| Specific gravity at 23° C. | 0.9671 | 0.9422 | 0.9473 | 0.944 |

### Sample Preparation Using a Twin Screw Extruder (TSE)

The following description explains the process employed in the following samples unless otherwise specified. A co-rotating, fully intermeshing type twin screw extruder, supplied by Coperion Corporation, Ramsey N.J., was used following a method similar to that described in U.S. Pat. No. 4,594,391 and US 2011/0028637 (excepting those altered conditions identified here). BIMSM was fed into the feed throat of a ZSK 53 extruder of L/D (length of extruder over its diameter) of about 44. The thermoplastic resin (polypropylene, and soft thermoplastic elastomer phase if present) was also fed into the feed throat along with other reaction rate control agents such as fillers, such as talc, were also added into the extruder feed throat. Process oil was injected into the extruder at locations along the extruder. The curative was injected into the extruder after the rubber, thermoplastics and fillers commenced blending at, but after the introduction of first process oil (pre-cure oil). In some examples, the curative was injected with the process oil, which oil may or may not have been the same as the other oil introduced to the extruder or the oil the rubber was extended with. The process oil can be injected at more than one location along the extruder. Rubber crosslinking reactions were initiated and controlled by balancing a combination of viscous heat generation due to application of shear, barrel temperature set point, use of catalysts, and residence time.

The extruded materials were fed into the extruder at a rate of 70 kg/hr and the extrusion mixing was carried out at 325 revolutions per minute (RPM), unless specified. A barrel metal temperature profile in ° C., starting from barrel section 2 down towards the die to barrel section 12 of 160/160/160/160/165/165/165/165/180/180/180/180° C. (wherein the last value is for the die) was used. Low molecular weight contaminants, reaction by-products, residual moisture and the like were removed by venting through one or more vent ports, typically under vacuum, as needed. The final product was filtered using a melt gear pump and a filter screen of desired mesh size. A screw design with several mixing sections including a combination of forward convey, neutral, left handed kneading blocks and left handed convey elements to mix the process oil, cure agents and provide sufficient residence time and shear for completing the cure reaction, without slip or surging in the extruder, were used.

Table 6 shows composition of inventive TPV compositions that offer excellent balance of processability, punch force, resealability, and tensile properties.

MgO: is a high purity, lightly calcined, high surface area, very active magnesium oxide. Its primary use to neutralize acids formed during the processing of elastomer compounds. This high quality magnesium oxide is produced through a precision controlled seawater extraction process, which produces consistent unique crystal morphology and very narrow particle size distribution for applications where fast reaction rates are required.

Available under the tradename, MAGLITE D (RX-13856) from Hallstar.

HCR: Hydrocarbon resin,with a softening point of 137.7° C., used as a performance modifier resin in blends with polymers. Available under the tradename, Oppera from ExxonMobil.

OBC-1: An olefin block copolymer composite comprising, an ethylene-propylene

(EP) copolymer, isotactic polypropylene (iPP), and an EP-iPP diblock polymer; melt flow rate (230° C., 2.16kg) of 7 g/10 min, overall ethylene content of 29 wt %, tensile stress at break of 10.8 MPa, Vicat softening point of 124° C.; available under the tradename, Intune from Dow;

OBC-2: The OBC's consist of crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C. This gives the polymer much better elevated temperature resistance and elasticity compared to a typical metallocene random polymer of similar density. Available under the tradename, Infuse from Dow; density of 0.877 g/cm³, melting point Tm of 122° C., shore A hardness of 69, Ultimate tensile strength at break of 10 MPa, and compression set at 70° C. of 55%.

Polybutene Oil: is a low molecular polybutene polymer of number average molecular weight Mn =910 g/mol as per GPC, flash point >210° C., Viscosity Index of 125.

Available under the tradename Indopol.

TABLE 6
Blend Compositions

| Formulation | E7 | E8 | E9 | E10 | E11 | E12 | E13 | E14 | E15 | E16 | E17 |
|---|---|---|---|---|---|---|---|---|---|---|---|
| BIMSM-2 | 100 | 100 | 100 | 100 | 100 | 100 | 100 | 100 | 100 | 100 | 100 |
| Talc | 5 | 5 | 5 | 5 | 5 | 5 | 5 | 5 | 5 | 5 | 5 |
| MgO | 2 | 2 | 2 | 2 | 2 | 2 | 2 | 2 | 2 | 2 | 2 |
| HCR | | | 20 | | | | | | | | |
| PP-2 | 8 | 8 | 8 | 8 | 8 | 8 | 16 | 8 | 8 | 16 | 8 |
| OBC-1 | 37 | | | | 45 | 50 | 37 | | | | 15 |
| OBC-2 | | 37 | 40 | 50 | | | | 55 | 60 | 44 | 37 |
| Polybutene oil | 40 | 40 | | 40 | 60 | 70 | 70 | 50 | 65 | 65 | 60 |
| Amine cure-1 | 2 | 2 | 2 | 2 | 2 | 2 | 2 | 2 | 2 | 2 | 2 |
| Total (phr) | 194 | 194 | 177 | 207 | 222 | 237 | 232 | 222 | 242 | 234 | 229 |

Test methods:

Shore A hardness is determined according to ISO 868 with a 15 second interval and/or per ASTM D-2240 with a 5 second time interval;

M100 is determined according to ASTM D-412;

Tensile strength is determined according to ASTM D-412;

Elongation at break is determined according to ASTM D-412;

Stress at 100% strain is determined according to ASTM D-412;

Tension set is determined according to ASTM D-412 at room temperature after 100% elongation;

Compression set is determined according to ASTM D-395 Method B at room temperature, 70° C., and, 100° C.;

LCR Viscosity is determined using a Dynisco® capillary rheometer at 12001/s and 202° C.

O₂ Gas permeability was measured according to ISO 2782-1: 2012(E) in which the thickness of each sample was measured at 5 points homogeneously distributed over the sample permeation area. The test specimen was bonded onto the holders with suitable adhesive cured at the test temperature. The chamber was evacuated by pulling vacuum on both sides of the film. The high pressure side of the film was exposed to the test pressure with O₂ gas at 23° C. and 40° C. The test pressure and temperature was maintained for the length of the test, recording temperature and pressure at regular intervals. The sample was left under pressure until steady state permeation has been achieved (3-5 times the time lag).

Punch Force, Self-sealing, and Fragmentation performance was measured according to process specified in the United States Pharmacopeia (USP) 381 “Elastomeric Closure for Injections” standards. Surface roughness was tested on Model Perthometer S2 surface measuring equipment

Table 7 shows properties of inventive TPV compositions that are useful as pharmaceutical stoppers. The TPV compositions show excellent processability as shown from the low LCR viscosity data of less than 300 Pa·s at 1200 1/s which is common in injection molding application that shows that the materials can be successfully injection molded at the conditions selected in to a pharmaceutical stopper. Additionally, as shown in Table 7, the TPV compositions exhibit excellent compression set of less than 20% at room temperature and less than 30% at 70° C. This is important to ensure that sealing is not comprised when switching from thermoset stoppers to injection moldable TPV stoppers. Moreover, the TPV stoppers show exceptional barrier to oxygen which is comparable to thermoset Exxpro stoppers.

TABLE 7
Physical properties

| Properties | E7 | E8 | E9 | E10 | E11 | E12 | E13 | E14 | E15 | E16 | E17 |
|---|---|---|---|---|---|---|---|---|---|---|---|
| Viscosity, | 234 | 247 | 320 | 233 | 173 | 160 | 138 | 196 | 157 | 144 | 172 |
| 1200 1/s, 204° C. | | | | | | | | | | | |
| Shore A Hardness | 61 | 47 | 56 | 49 | 58 | 57 | 62 | 45 | 43 | 46 | 45 |
| Tensile strength, MPa | 3.5 | 3.3 | 4.8 | 3.6 | 3.5 | 3.2 | 3.4 | 3.1 | 2.5 | 2.0 | 3.0 |
| Tensile elongation, % | 223 | 283 | 334 | 337 | 257 | 253 | 247 | 341 | 366 | 271 | 312 |
| M100, MPa | 1.1 | 0.7 | 0.8 | 0.7 | 1.1 | 1.0 | 1.1 | 0.7 | 0.6 | 0.6 | 0.7 |
| Compression set, | | | | | 17 | 16 | 17 | 11 | 13.5 | 12 | 10 |
| RT, 25% | | | | | | | | | | | |
| Compression set, | | | | | 26 | 27.5 | 29 | 23.8 | 26.5 | 28 | 24.6 |
| 70° C., 25% | | | | | | | | | | | |
| CS, 100° C., 25% | | | | | 34.5 | 35 | 36 | 34.6 | 40 | 35 | 35.5 |
| Tension set, RT, 100% | 6.5 | 4.3 | 4.8 | 4.2 | 6.8 | 7.0 | 8.5 | 4.5 | 3.8 | 4.5 | 4.3 |
| Oxygen Permeability @ | 0.199 | 0.110 | 0.019 | 0.082 | 0.065 | 0.066 | 0.155 | 0.237 | 0.110 | 0.020 | 0.251 |
| 23° C., cc*mm/(m²- | | | | | | | | | | | |
| day-mmHg) | | | | | | | | | | | |
| Oxygen Permeability @ | 0.295 | 0.382 | 0.077 | 0.180 | 0.371 | 0.521 | 0.235 | 0.509 | 0.445 | 0.296 | 0.395 |
| 40° C., cc*mm/(m²- | | | | | | | | | | | |
| day-mmHg) | | | | | | | | | | | |

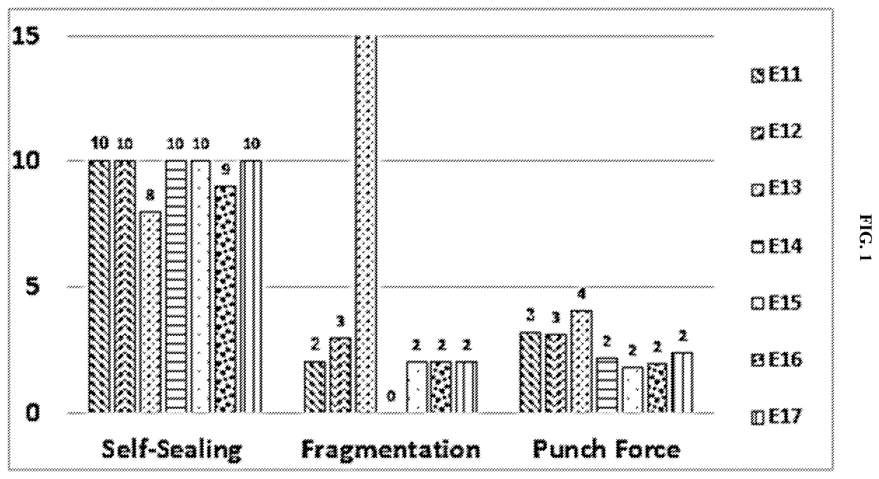

FIG. 1 shows testing related to pharmaceutical stopper properties. TPV stoppers must meet certain requirements relating to self-sealing, fragmentation, and punch force to be useful for pharmaceutical applications. As seen from FIG. 1, the inventive TPV compositions shown above show excellent self-sealing that is comparable to Exxpro thermoset. Importantly, very low fragmentation and punch force was observed for the TPV compositions which indicates that needle can penetrate the septum or stopper easily while not tracking any rubber particles on the needle.

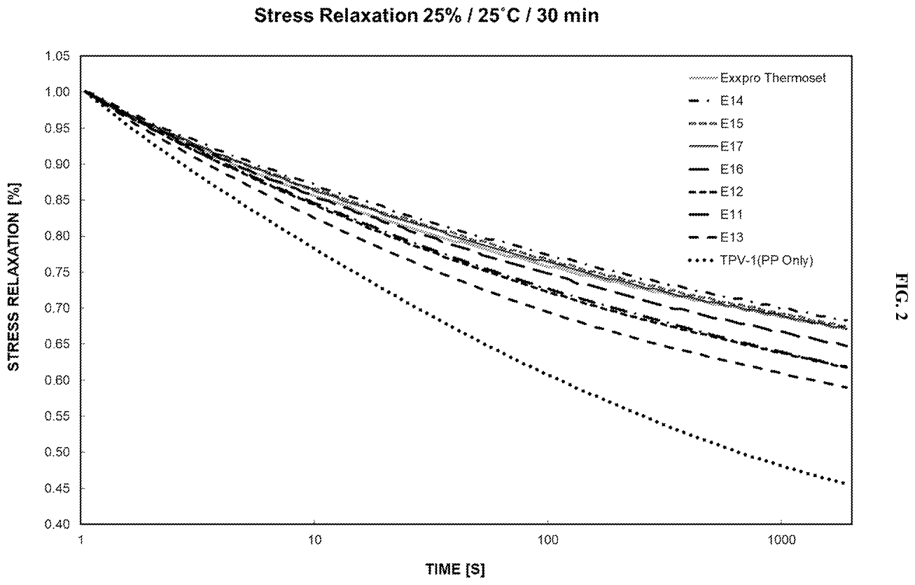

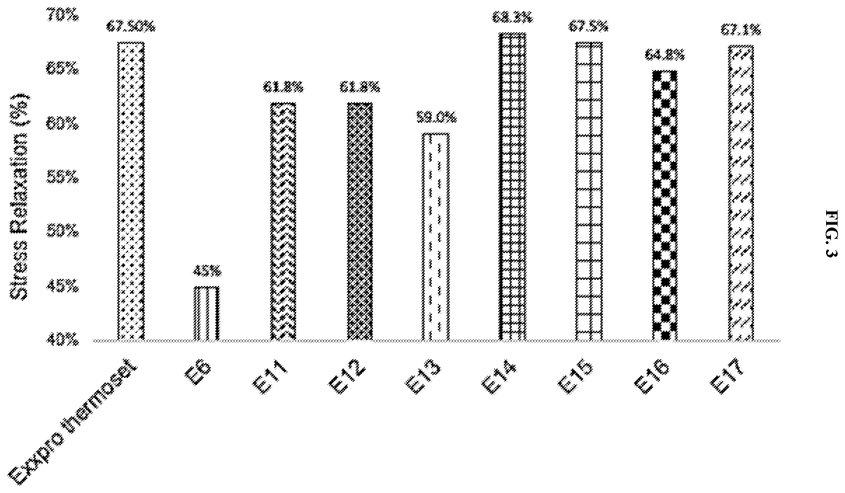

Stress relaxation slope was measured in compression according to ISO 3384A using an Elastocon stress relaxation tester. The samples are plied up to 2 mm thickness and compressed to 10% deflection at 70° C. and for 24 h. A plot of normalized force (normalized with respect to force @ t=0.01 s) as a function of time was constructed. The slope of this plot is defined as stress relaxation slope and has units of 1/min. FIG. 2 and FIG. 3 show that stress relaxation is improved over compositions without soft thermoplastic elastomer, and comparable to thermoset Exxpro alone.

In the remaining examples, different preparations of thermoplastic vulcanizates are provided, each including a soft thermoplastic elastomer. Each of these examples provide thermoplastic vulcanizates that are injection moldable and have performance properties suitable for use in pharmaceutical stoppers and that are comparable to thermoset Exxpro, which is not injection moldable.

### Sample Preparation Using Brabender Mixer

Thermoplastic vulcanizates were prepared by dynamically vulcanizing an elastomeric copolymer within a Brabender mixer using conventional procedures by effecting vulcanization with an amine curing agent. Specifically, thermoplastic vulcanizates were prepared in a laboratory Brabender-Plasticorder (model EPL-V5502). The mixing bowls had a capacity of 85 ml with the cam-type rotors employed. The rubber was initially added to the mixing bowl that was heated to 180° C. and at 100 rpm rotor speed. Subsequently, the plastic (typically in pellet form), and talc, were packed in to the mixer and melt mixed for two minutes. The polybutene oil (pre-cure oil) was then added drop-wise over a minute, and mixing was continued for 1-5 minutes (a steady torque was obtained at this time) before the addition of the phenolic resin. The amine curing agent was then added to the mixing bowl, followed by the addition of stannous chloride MB, which caused an increase in motor torque due to occurrence of the curing reaction.

Mixing was continued for about 4 more minutes, after which the molten TPV was removed from the mixer, and pressed when hot between Teflon plates into a sheet which was cooled, cut-up, and compression molded at about 400° F. A Wabash press, model 12-1212-2 TMB was used for compression molding, with 4.5″×4.5″×0.06″ mold cavity dimensions in a 4-cavity Teflon-coated mold. Material in the mold was initially preheated at about 400° F. (204.4° C.) for about 2-2.5 minutes at a 2-ton pressure on a 4″ ram, after which the pressure was increased to 10-tons, and heating was continued for about 2-2.5 minutes more. The mold platens were then cooled with water, and the mold pressure was released after cooling (about 70° C.).

Clay used is a calcined clay available under the tradename Polestar.

PP-3: a homopolymer resin designed for spunbond nonwovens. The resin has a density of 0.90 g/cm³, and melt flow rate of 36 g/10 min (230° C., 2.16 kg). It is available from ExxonMobil.

PBE-1: is primarily composed of isotactic propylene repeat units with random ethylene distribution, and is produced using metallocene catalyst. The sample has density of 0.862 g/cm³, melt index (190° C./2.16 kg) of 9.1 g/10 min, ethylene content of 15 wt %, shore A hardness of 64, tensile strength at break of 5.5 MPa (ASTM D412). It is available from ExxonMobil.

PBE-2: is primarily composed of isotactic propylene repeat units with random ethylene distribution, and is produced using metallocene catalyst. The sample has density of 0.873 g/cm³, melt index (190° C./2.16 kg) of 3.7 g/10 min, ethylene content of 11 wt %, shore D hardness of 27, tensile strength at break of 14 MPa (ASTM D412). It is available from ExxonMobil.

TABLE 8
Blend Compositions

| Formulation | E18 | E19 | E20 |
|---|---|---|---|
| BIMSM-2 | 100 | 100 | 100 |
| Clay | 10 | 10 | 10 |
| Polybutene oil | 64.3 | 64.3 | 64.3 |
| PP-3 | 37 | 26 | 26 |
| PBE-1 | | 11 | |
| PBE-2 | | | 11 |
| Amine cure-1 | 3.5 | 3.5 | 3.5 |
| Total (phr) | 214.8 | 214.8 | 214.8 |

TABLE 9
Physical properties

| Properties | E18 | E19 | E20 |
|---|---|---|---|
| Shore A Hardness | 67 | 60 | 60 |
| Modulus, 100%, MPa | 2.67 | 2.06 | 2.15 |
| Tensile strength at break, MPa | 4.63 | 4.31 | 4.71 |
| Elongation at break, % | 228 | 251 | 274 |
| Compression set, 70° C., 25% deflection | 39 | 39 | 42 |

TABLE 10
Physical properties

| | | |
|---|---|---|
| E18 | E19 | E20 |

Punch Force Test

| | | | |
|---|---|---|---|
| Max. Force(N) out of 10 Puncture @ | 17.823 | 16.845 | 17.518 |
| one per Vial | | | |

Self Sealing Test

| | | | |
|---|---|---|---|
| No. of Vials Passed out of 10 Vial Samples | 8 | 10 | 10 |

Fragmentation Test

| | | | |
|---|---|---|---|
| No. of Fragmented Particles out of 48 | 18 | 12 | 14 |
| Puncture of 12 vials (4 puncture × 12 | | | |
| no of vials = 48) | | | |

Pharmaceutical Compositions with Various Thermoplastic Resins

Following examples contain only soft thermoplastic elastomer in the thermoplastic phase

COC-1: TOPAS™ 8007. Commercial cyclic olefin copolymer with density of 1010 kg/m³ (ISO 1183), melt volume rate (190° C./2.16 kg) of 2 cm³/10 min (ISO1133), glass transition temperature of 78° C. (10° C./min, ISO11357-1,-2,-3), and nominal norbornene content of 66-68 wt %.

4MP-1 is a 4-methyl-1-pentene/propylene copolymer with a melt flow rate of 10 g/10 min (230° C., 2.16kg). The copolymer has a shore D hardness of 55, tensile strength at break of 30 MPa, a Tg of 40° C. as measured by DSC, and melting point of 130° C. The copolymer is available from Mitsui Chemicals under the trade name Absortomer™.

PE-1 is a pipe extrusion grade HDPE copolymer offering an excellent stiffness and stress crack resistance. PE-1 has density of 0.953 g/cm³, melt index of 0.25 g/10 min (190° C./2.16 kg), tensile strength at yield of 28 MPa, Flexural modulus of 970 MPa.

MB1: anhydrous SnCl2 master batch with polypropylene homopolymer and SnCl₂ (45 wt %).

ZnO: Commercial ZnO cure moderator/acid scavenger available under the tradename Kadox™ 911.

Phenolic Resin: Phenolic resin is an octyl phenolic resin.

Clay: Calcined clay obtained under the tradename Icecap™ K Clay (available from Burgess™)

TABLE 11
Blend Compositions

| Formulation | E21 | E22 | E23 | E24 | E25 | E26 |
|---|---|---|---|---|---|---|
| BIMSM-2 | 100 | 100 | 100 | 100 | 100 | 100 |
| Clay | 10 | 10 | 10 | 10 | 10 | 10 |
| Polybutene oil | 64 | 64 | 64 | 64 | 64 | 64 |
| PP-1 | 37 | | | | | |
| COC-1 | | 37 | | | | |
| OBC-1 | | | 37 | | | |
| OBC-2 | | | | 37 | | |
| 4MP-1 | | | | | 37 | |
| PE-1 | | | | | | 37 |
| SnCl₂ MB | 1.3 | 1.3 | 1.3 | 1.3 | 1.3 | 1.3 |
| Phenolic Resin | 5 | 5 | 5 | 5 | 5 | 5 |
| MgO | 2 | 2 | 2 | 2 | 2 | 2 |
| ZnO | 4 | 4 | 4 | 4 | 4 | 4 |
| Total (phr) | 224.3 | 224.3 | 224.3 | 224.3 | 224.3 | 224.3 |

TABLE 12
Physical properties

| Properties | E21 | E22 | E23 | E24 | E25 | E26 |
|---|---|---|---|---|---|---|
| Shore A Hardness | 57 | 52 | 36 | 20 | 49 | 37 |
| Modulus, 100%, MPa | 2.2 | 2.0 | 0.9 | 0.4 | 1.8 | 1.2 |
| Tensile strength at break, MPa | 5.8 | 3.4 | 3.1 | 1.5 | 5.0 | 2.9 |
| Elongation at break, % | 381 | 256 | 417 | 464 | 380 | 354 |
| Tension set, % | 11.5 | 22.3 | 11.0 | — | 8.3 | 12.2 |
| (70° C., 25%) | | | | | | |

TABLE 13
Physical properties

| | | | | | |
|---|---|---|---|---|---|
| E21 | E22 | E23 | E24 | E25 | E26 |

Punch Force Test

| | | | | | |
|---|---|---|---|---|---|
| Max. Force(N) out of 10 | 4.9 | 4.5 | 2.0 | 4.0 | 3.6 |
| Puncture @ one per Vial | | | | | |

Self Sealing Test

| | | | | | |
|---|---|---|---|---|---|
| No. of Vials Passed out | 8 | 5 | 10 | 10 | 10 |
| of 10 Vial Samples | | | | | |

Fragmentation Test

| | | | | | |
|---|---|---|---|---|---|
| No. of Fragmented Particles | 5 | 7 | 5 | 4 | 6 |
| out of 48 Puncture of 12 | | | | | |
| vials (4 puncture × 12 no | | | | | |
| of vials = 48) | | | | | |

Pharmaceutical Composition with Thermoplastic Blends

4MP-2 1 is a 4-methyl-1-pentene/propylene copolymer with a melt flow rate of 10 g/10 min (230° C., 2.16kg). Density of 0.840 g/cm³, shore A hardness of 70, the copolymer has a tensile strength at break of 27 MPa, a Tg of 30° C. as measured by DSC, and no melting point detected. The copolymer is available from Mitsui Chemicals under the trade name Ab sortomer™.

TABLE 14
Blend Compositions

| Formulation | E27 | E28 | E29 | E30 | E31 | E32 | E33 | E34 | E35 |
|---|---|---|---|---|---|---|---|---|---|
| BIMSM-2 | 100 | 100 | 100 | 100 | 100 | 100 | 100 | 100 | 100 |
| Clay | 10 | 10 | 10 | 10 | 10 | 10 | 10 | 10 | 10 |
| Polybutene oil | 64 | 64 | 64 | 64 | 64 | 64 | 64 | 64 | 64 |
| PP-1 | 14.8 | 14.8 | 22.2 | 14.8 | 22.2 | 14.8 | 22.2 | 14.8 | 22.2 |
| COC-1 | 22.2 | | | | | | | | |
| OBC-1 | | 22.2 | 14.8 | | | | | | |
| OBC-2 | | | | 22.2 | 14.8 | | | | |
| 4MP-1 | | | | | | 22.2 | 14.8 | | |
| 4MP-2 | | | | | | | | 22.2 | 14.8 |
| SnCl₂ MB | 1.3 | 1.3 | 1.3 | 1.3 | 1.3 | 1.3 | 1.3 | 1.3 | 1.3 |
| Phenolic Resin | 5 | 5 | 5 | 5 | 5 | 5 | 5 | 5 | 5 |
| MgO | 2 | 2 | 2 | 2 | 2 | 2 | 2 | 2 | 2 |
| ZnO | 4 | 4 | 4 | 4 | 4 | 4 | 4 | 4 | 4 |
| Total (phr) | 224.3 | 224.3 | 224.3 | 224.3 | 224.3 | 224.3 | 224.3 | 224.3 | 224.3 |

TABLE 15
Physical properties

| Properties | E27 | E28 | E29 | E30 | E31 | E32 | E33 | E34 | E35 |
|---|---|---|---|---|---|---|---|---|---|
| Shore A Hardness | 47 | 43 | 49 | 29 | 38 | 45 | 48 | 31 | 41 |
| Modulus, 100%, MPa | 1.7 | 1.3 | 1.6 | 0.8 | 1.1 | 1.5 | 1.6 | 0.8 | 1.2 |
| Tensile strength | 3.6 | 3.8 | 4.3 | 2.5 | 3.7 | 4.7 | 4.9 | 4.1 | 4.8 |
| at break, MPa | | | | | | | | | |
| Elongation | 263 | 373 | 349 | 324 | 386 | 389 | 379 | 394 | 400 |
| at break, % | | | | | | | | | |
| Tension set, % | 18.5 | 10.5 | 11.3 | 8.5 | 10 | 11.8 | 11 | 10.8 | 10.2 |
| (70° C., 25%) | | | | | | | | | |

TABLE 16
Physical properties

| | | | | | | | | |
|---|---|---|---|---|---|---|---|---|
| E27 | E28 | E29 | E30 | E31 | E32 | E33 | E34 | E35 |

Punch Force Test

| | | | | | | | | | |
|---|---|---|---|---|---|---|---|---|---|
| Max. Force(N) out of 10 | 4.3 | 2.4 | 3.0 | 2.3 | 2.7 | 3.7 | 4.0 | 2.5 | 3.3 |
| Puncture @ one per Vial | | | | | | | | | |

Self Sealing Test

| | | | | | | | | | |
|---|---|---|---|---|---|---|---|---|---|
| No. of Vials Passed out | 10 | 10 | 10 | 10 | 10 | 10 | 10 | 10 | 10 |
| of 10 Vial Samples | | | | | | | | | |

Fragmentation Test

| | | | | | | | | | |
|---|---|---|---|---|---|---|---|---|---|
| No. of Fragmented Particles | 4 | 2 | 3 | 3 | 4 | 6 | 4 | 3 | 2 |
| out of 48 Puncture of 12 | | | | | | | | | |
| vials (4 puncture × 12 no | | | | | | | | | |
| of vials = 48) | | | | | | | | | |

Styrene/isobutylene/styrene elastomers as blend

SIBS-1: is a triblock copolymer of styrene/isobutylene/styrene. The copolymer has a shore A hardness of 25, melt flow rate of 0.6 g/10 min (230° C., 2.16kg), tensile strength of 15 MPa, compression set at 70° C. of 65%.

SIBS-2: is a triblock copolymer of styrene/isobutylene/styrene. The copolymer has a shore A hardness of 46, melt flow rate of 0.1 g/10 min (230° C., 2.16kg), tensile strength of 18 MPa, compression set at 70° C. of 50%.

TABLE 17
Blend Compositions

| Formulation | E36 | E37 | E38 | E39 | E40 | E41 | E42 |
|---|---|---|---|---|---|---|---|
| BIMSM-2 | 100 | 100 | 100 | 100 | 100 | 100 | 100 |
| Talc | 7 | 7 | 7 | 7 | 7 | 7 | 7 |
| Polybutene oil | 40 | 40 | 40 | 40 | 40 | 40 | 40 |
| PP-2 | 22 | 22 | 17 | 22 | 17 | 22 | 22 |
| PP-1 | 15 | | | | | | |
| SIBS-1 | | 15 | 20 | | | 15 | |
| SIBS-2 | | | | 15 | 20 | | 15 |
| SnCl₂ MB | 1.3 | 1.3 | 1.3 | 1.3 | 1.3 | | |
| Phenolic Resin | 5 | 5 | 5 | 5 | 5 | | |
| MgO | 2 | 2 | 2 | 2 | 2 | | |
| ZnO | 4 | 4 | 4 | 4 | 4 | | |
| Amine cure-1 | | | | | | 3.5 | 3.5 |
| Total (phr) | 196.3 | 224.3 | 224.3 | 224.3 | 224.3 | 187.5 | 187.5 |

TABLE 18
Physical properties

| Properties | E36 | E37 | E38 | E39 | E40 | E41 | E42 |
|---|---|---|---|---|---|---|---|
| Shore A Hardness | 67.5 | 49 | 42 | 52 | 44 | 49 | 50 |
| Tension Set, % set (10% | 10.7 | 4.8 | 4.0 | 6.0 | 3.2 | 7.7 | 3.2 |
| Elongation) 10 minutes at | | | | | | | |
| RT, release for 10 minutes | | | | | | | |
| then measure | | | | | | | |

All documents described herein are incorporated by reference herein, including any priority documents and/or testing procedures to the extent they are not inconsistent with this text. As is apparent from the foregoing general description and the specific embodiments, while some embodiments have been illustrated and described, various modifications can be made without departing from the spirit and scope of the disclosure. Accordingly, it is not intended that the disclosure be limited thereby. Likewise, the term “comprising” is considered synonymous with the term “including.” Likewise whenever a composition, an element or a group of elements is preceded with the transitional phrase “comprising”, it is understood that we also contemplate the same composition or group of elements with transitional phrases “consisting essentially of ” “consisting of”, “selected from the group of consisting of,” or “is” preceding the recitation of the composition, element, or elements and vice versa.

1. A thermoplastic elastomer composition comprising:
one or more brominated isobutylene paramethyl-styrene terpolymers; and
10 to 80 parts by weight per hundred parts by weight rubber (phr) of a polypropylene homopolymer;
wherein the thermoplastic elastomer composition is cured using a phenolic resin-based cure system, a sulfur-based cure system, or an amine-based cure system.

2. The thermoplastic elastomer composition of claim 1, wherein the polypropylene homopolymer is present at 20 to 40 phr.

3. The thermoplastic elastomer composition of claim 1, wherein a process oil is present at 10 to 100 phr.

4. The thermoplastic elastomer composition of claim 3, wherein the process oil comprises a polyisobutene polymer.

5. The thermoplastic elastomer composition of claim 1, wherein the phenolic resin-based cure system comprises curing agents including one or more of:
0.1 to 20 phr of stannous chloride;
0.1 to 15 phr of metal oxide;
0.05 to 10 phr of stearic acid; and
0.5 to 20 phr of phenolic resin.

6. The thermoplastic elastomer composition of claim 1, wherein the sulfur-based cure system comprises sulfur curing agents including one or more of:
0.1 to 10 phr of MBTS;
0.01 to 5 phr of sulfur;
0.1 to 10 phr of metal oxide; and
0.5 to 15 phr of stearic acid.

7. The thermoplastic elastomer composition of claim 1, wherein the amine-based cure system comprises one or more amine curing agents present at 0.1 to 10 phr and wherein the one or more amine curing agents is selected from (6-aminohexyl)carbamic acid, N,N′-dicinnamylidene-1,6-hexamethylenediamine, 4,4′-methylenebis(cyclohexylamine)carbamate, 1,3,5-triallyl-1,3,5-triazine-2,4,6(1H,3H,5H)-trione, trimethylallyl isocyanurate, N-(1,3-dimethylbutyl)-N′-phenyl-p-phenylenediamine, N,N′-Diphenyl-p-phenylenediamine, N,N-Diethyl-p-phenylenediamine.

8. The thermoplastic elastomer composition of claim 1, wherein the composition exhibits one or more of the following qualities:
a specific gravity at about 23° C. of from 0.8 g/cm3 to 1 g/cm3;
a moisture vapor (%) of from 0.01% to 0.03%;
an extrusion surface Ra (pm) of from 140 to 190;
a Tensile Strength (MPa) of from 1 to 10;
a 100% Modulus (MPa) of from 1 to 5;
an elongation at break (%) of from 100 to 500; or,
a permeability (cc.mm/m2.day.mmHg) of from 0.1 to 1.

9. The thermoplastic elastomer composition of claim 1,
wherein the thermoplastic elastomer composition has a hardness (Shore A) of 20 to 90.

10. The thermoplastic elastomer composition of claim 1, wherein the thermoplastic elastomer composition is at least partially crosslinked.

11. A thermoplastic vulcanizate composition comprising:
an elastomer phase comprising one or more brominated isobutylene paramethyl-styrene terpolymers;
10 to 90 parts by weight per hundred parts by weight rubber (phr) of a thermoplastic phase comprising a blend of one or more thermoplastic polyolefins and one or more soft thermoplastic elastomers, wherein the soft thermoplastic elastomer has a shore A hardness from 20 to 96, a shore D hardness from 20 to 50 and a tensile strength at break of 2 to 20 MPa; and
10 to 100 phr of a process oil;
wherein the elastomer phase is cured using a phenolic resin-based cure system or an amine-based cure system.

12. The thermoplastic vulcanizate composition of claim 11, wherein the one or more soft thermoplastic elastomers comprises an olefin based block copolymer comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C.

13. The thermoplastic vulcanizate composition of claim 11, wherein the one or more soft thermoplastic elastomers comprises a propylene based olefin block copolymer (OCP) blend comprising an ethylene-propylene (EP) copolymer, isotactic polypropylene (iPP) and an EP-iPP diblock polymer.

14. The thermoplastic vulcanizate composition of claim 11, wherein the one or more soft thermoplastic elastomers comprises a styrene-isobutylene styrene (SIBS) polymer.

15. The thermoplastic vulcanizate composition of claim 11, wherein the one or more soft thermoplastic elastomers comprises a propylene-based elastomer containing units derived from major fraction of propylene and from about 5 to about 25 wt % of one or more comonomers selected from ethylene and/or C4-C12 α-olefins.

16. The thermoplastic vulcanizate composition of claim 11, wherein the one or more soft thermoplastic elastomers comprises a 4-methyl-1-pentene/α-olefin copolymer comprising 50 to 100% by weight of structural units derived from methyl-1-pentene and 0 to 50% by weight of structural units derived from at least one olefin selected from olefins having 2 to 20 carbon atoms, except 4-methyl-1-pentene.

17. The thermoplastic vulcanizate composition of claim 11, wherein the one or more soft thermoplastic elastomers comprises one or more of the following:
(1) an olefin based block copolymer comprising crystallizable ethylene-octene blocks with less than 10 wt % alphα-olefin comonomer content and a melting point greater than 90° C., alternating with low crystallinity ethylene-octene blocks with comonomer content greater than 10 wt % and a melting point of less than 90° C.,
(2) a propylene based olefin block copolymer (OCP) blend comprising an ethylene-propylene (EP) copolymer, isotactic polypropylene (iPP) and an EP-iPP diblock polymer,
(3) a styrene-isobutylene styrene (SIBS) polymer,
(4) a propylene-based elastomer containing units derived from major fraction of propylene and from about 5 to about 25 wt % of one or more comonomers selected from ethylene and/or C4-C12 α-olefins, and
(5) a 4-methyl-1-pentene/α-olefin copolymer comprising 50 to 100% by weight of structural units derived from 4-methyl-1-pentene and 0 to 50% by weight of structural units derived from at least one olefin selected from olefins having 2 to 20 carbon atoms, except 4-methyl-1-pentene, or any combination thereof.

18. The thermoplastic vulcanizate composition of claim 11, wherein the one or more thermoplastic polyolefins comprises a propylene-based polymer, an ethylene-based thermoplastic polymer, a polypropylene homopolymer (PPH), or any combination thereof.

19. The thermoplastic vulcanizate composition of claim 12, wherein the olefin based block copolymer exhibits one or more of the following qualities:
(1) a melt flow rate (MFR) (190° C./2.16 kg) of 0.5 to 30 g/10 min,
(2) a melting temperature from 100 to 130° C.,
(3) a shore A hardness from 30 to 95, or
(4) a tensile strength from 1.5 to 18 MPa.

20. The thermoplastic vulcanizate composition of claim 13, wherein the propylene based olefin block copolymer (OBC) blend exhibits one or more of the following qualities:
(1) a melt flow rate (MFR) (230° C./2.16 kg) of 0.5 to 100 g/10 min, based on the ASTM D1238 test method,
(2) a shore A hardness from 30 to 98,
(3) a shore D hardness from 5 to 60,
(4) an ethylene content of 90 to 15 wt %,
(5) a vicat softening point of 20 to 150° C., or
(6) a tensile strength at break of 1.5 to 20 MPa.

21. The thermoplastic vulcanizate composition of claim 14, wherein the styrene-isobutylene styrene (SIBS) polymer exhibits one or more of the following qualities:
(1) a melt flow rate (MFR) (230° C./2.16 kg) of 0.05 to 30 g/10 min,
(2) a tensile strength at break from 4 to 25 MPa,
(3) a shore A hardness from 15 to 60, or
(4) a compression set at 70° C. from 30 to 120%.

22. The thermoplastic vulcanizate composition of claim 15, wherein the propylene-based elastomer exhibits one or more of the following qualities:
(1) a melt flow rate (MFR) (190° C./2.16 kg) 0.2 to 25 g/10 min,
(2) ethylene content from 1 to 25 wt %, or
(3) a melting temperature from 20 to 110° C.

23. The thermoplastic vulcanizate composition of claim 16, wherein the 4-methyl-1-pentene/α-olefin copolymer exhibits one or more of the following qualities:
(1) a melt flow rate (MFR) (230° C., 2.16 kg) from 0.5 to 20 g/10 min,
(2) a tensile strength at break from 20 to 30 MPa, or
(3) a glass transition temperature (Tg) from -10 to 50° C.

24. The thermoplastic vulcanizate composition of claim 11 wherein the elastomer phase is cured using amine cure system comprising one or more amine curing agents present at 0.1 to 10 phr and wherein the one or more amine curing agents is selected from (6-am inohexyl)carbamic acid, N,N′-dicinnamylidene-1,6-hexamethylenediamine, 4,4′-methylenebis(cyclohexylamine)carbamate, 1,3,5-triallyl-1, 3, 5-triazine-2,4,6(1H,3H,5H)-trione, trimethylallyl isocyanurate, N-(1,3-dimethylbutyl)-N′-phenyl-p-phenylenediamine, N, N′-Diphenyl-p-phenylenediamine, N, N-Diethyl-p-phenylenediamine.

25. The thermoplastic vulcanizate composition of any claim 11, wherein the cure system is substantially free of heavy metal fractions, phenolic resin or sulfur.

26. The thermoplastic vulcanizate composition of claim 11, wherein the process oil comprises a polyisobutene polymer.

27. The thermoplastic vulcanizate composition of 11, wherein the process oil comprises a styrene-isobutylene styrene polymer.

28. The thermoplastic vulcanizate composition of claim 11, wherein the process oil comprises a propylene-based elastomer containing units derived from major fraction of propylene and from about 5 to about 25 wt % of one or more comonomers selected from ethylene and/or C4-C12 α-olefins.

29. The thermoplastic vulcanizate composition of claim 11, further comprising a cyclopentadiene-based hydrocarbon resin having a glass transition temperature (Tg) of greater than 20° C.

30. The thermoplastic vulcanizate composition of claim 11, wherein the elastomer phase is at least partially crosslinked.

31. The thermoplastic vulcanizate composition of claim 11, wherein the composition exhibits one or more of the following qualities:
(1) a shore A hardness from 20 to 90,
(2) a tensile strength at break of 1.5 to 8 MPa,
(3) a compression set at 70° C. of <35%, or
(4) oxygen permeability <0.2 cc*mm/(m2-day-mmHg) measured at 40° C.

32. A pharmaceutical stopper comprising the thermoplastic vulcanizate composition of claim 11.
